(19) United States
(12) Patent Application Publication
(10) Pub. No.: US 2016/0180712 A1
(43) Pub. Date: Jun. 23, 2016

(54) CITYWIDE PARKING RESERVATION SYSTEM AND METHOD

(71) Applicant: Sparkcity.com Ltd., Tel Aviv (IL)

(72) Inventors: Itamar Rosen, Tel Aviv (IL); Haim Yosef Gotlieb, Beitar Illit (IL); Orri Ben-Nathan, Tel Aviv (IL); Elimelech Weissberg, Kfar Chabad (IL); Shai Yagur, Tel Aviv (IL)

(73) Assignee: Sparkcity.com Ltd., Tel Aviv (IL)

(21) Appl. No.: 15/058,766

(22) Filed: Mar. 2, 2016

Related U.S. Application Data
(63) Continuation-in-part of application No. PCT/IB2015/056509, filed on Aug. 27, 2015.
Application No. PCT/IB2015/056509 is a continuation-in-part of application No. PCT/IB2015/056512, filed on Aug. 27, 2015.
(60) Provisional application No. 62/042,445, filed on Aug. 27, 2014.
(60) Provisional application No. 62/042,445, filed on Aug. 27, 2014.

(51) Int. Cl. G08G 1/14; G06Q 10/02

(52) U.S. Cl. CPC G08G 1/148; G08G 1/144; G06Q 10/02

(57) ABSTRACT

A system including: (a) a database of individual on-street parking spots, and individual off-street parking spots, each of the individual parking spots associated with a unique identifier (UID) and location coordinates; and (b) an off street spot management module in communication one or more external client devices, adapted to receive parking rules from an external client device operated by an owner of each of the individual off-street parking spots.

### CROSS-REFERENCE TO RELATED APPLICATIONS

This is a Continuation-in-Part of International Patent Application No. PCT/IB2015/056509, filed Aug. 27, 2015, which claims the benefit of U.S. Provisional Patent Application No. 62/042,445, filed Aug. 27, 2014. This is also a Continuation-in-Part of International Patent Application No. PCT/IB2015/056512, filed Aug. 27, 2015, which claims the benefit of U.S. Provisional Patent Application No. 62/042,445, filed Aug. 27, 2014. All of the foregoing applications are incorporated by reference in their entirety herein.

### FIELD OF THE INVENTION

The invention is in the field of parking systems.

### BACKGROUND OF THE INVENTION

The problem of parking is frustrating to both drivers and municipalities. Substantial resources have been invested in finding a solution, but with little or no success, to date.

In many locations, there is a shortage of parking spots. Even when there are sufficient available parking spots, an individual driver often has difficulty locating an available spot thereby wasting precious time and money. In addition, the driver is faced with other issues such as locating his vehicle when returning to it.

On the city level, traffic congestion, air pollution, severe economic burden and a lack of control of urban parking facilities are just some of the problems faced in connection with parking.

### SUMMARY OF THE INVENTION

Existing technologies fall short of providing a complete parking solution, whereas Applicant has identified key components in providing a holistic solution to both drivers and parking facility managers, on the city level as well as at parking venues.

Embodiments of the invention provide a tool for drivers which increases parking efficiency while decreasing parking effort. This reduces wasted time and money for the driver, as well as pollution, infrastructure costs and other damage for the city.

Additionally, systems and methods according to embodiments of the invention provide efficient utilization of space, increasing the space available for parking in the city and providing better control of parking facilities for the city and parking owners.

A broad aspect of the invention relates to traffic control. More specifically various exemplary embodiments of the invention relate to parking reservation systems which assign parking spots to users based on availability. In some exemplary embodiments of the invention, users order parking spots using a user client device. According to various exemplary embodiments of the invention the user client devices are onboard computers (whether in a standard or driverless vehicle), smartphones, dedicated navigation devices (for example, a stand-alone GPS device) and/or tablet devices and/or laptop computers and/or wearable devices and/or desktop computers and/or 2G phones and/or specially equipped parking kiosks and/or and conventional phones (for example, operating through the Public Switched Telephone Network). Alternatively or additionally, in some embodiments parking docents carrying a user client device are deployed in order to assist drivers that do not have a user client device.

One aspect of some embodiments of the invention relates to incorporation of off street parking spots into a reservation system for on street parking spots. According to various exemplary embodiments of the invention the off street spots include privately owned individual spots and/or parking lots and/or parking garages.

Another aspect of some embodiments of the invention relates to flexible queue management for reservations of individual parking spots. In some embodiments the system, or a user thereof operating a user client device, makes an initial selection of an individual parking spot and is offered a spot which is closer to destination or has a lower hourly rate after the initial selection is made.

Another aspect of some embodiments of the invention relates to proximity based queue management of reservations for individual parking spots. In some embodiments the system provides information pertaining to one or more individual parking spots to a user client device when a threshold proximity to destination is crossed.

Another aspect of some embodiments of the invention relates to a virtual parking lot on demand. In some embodiments the system processes a bulk order for a future date. According to various exemplary embodiments of the invention the bulk order defines a future time and/or a number of spots required and/or a desired parking duration and/or a start time and/or destination and/or a maximum distance from therefrom.

Another aspect of some embodiments of the invention relates to use of a map indicating current status of parking spot. According to various exemplary embodiments of the invention such a map is employed by parking wardens to detect violations and/or by users to locate a spot assigned to them. In some embodiments the map provides context information for one or more spots. According to various exemplary embodiments of the invention the context information pertains to off street landmarks and/or cars currently parked in one or more adjacent spot. According to various exemplary embodiments of the invention the context information is provided as text and/or audio cues and/or pictorially. In some embodiments a tracking component of a user client device indicates to the system what portion of the map is relevant to that user client device.

Another aspect of some embodiments of the invention relates to use of a publicly available kiosk to provide a map indicating an available spot reserved in response to an order placed from the kiosk. In some embodiments the map includes navigation cues from the kiosk to the reserved spot. According to various exemplary embodiments of the invention the map is provided as a printout or as a digital file available for transfer to a device in proximity to the kiosk.

Another aspect of some embodiments of the invention relates to matching between vehicle attributes and spot features. According to various exemplary embodiments of the invention vehicle attributes include physical characteristics (e.g. engine type or required rear or side clearance) and status characteristics (e.g. handicap or resident). Alternatively or additionally, in some embodiments spot feature is a fixed physical item like an electric charger, rear or side lift clearance underground/open air (Many jurisdictions do not allow liquid propane powered vehicles to park in enclosed structures).

Another aspect of some embodiments of the invention relates to disregarding spots which are close to vehicle, but would be difficult to for that vehicle to reach when reserving a spot for the vehicle.

Another aspect of some embodiments of the invention relates to suggestion of an alternate destination in response to a request for a parking spot which includes an input destination. In some embodiments the alternate destination is in the same category as the input destination (e.g. substitution of one shopping mall for another; substitution of one supermarket for another supermarket in the same chain or substitution of one supermarket for another supermarket in a different chain but located in proximity to the input destination). In other exemplary embodiments of the invention, the alternate destination is a transportation hub providing public transportation service to a stop in proximity to the input destination.

Another aspect of some embodiments of the invention relates to identifying parking preferences for a vehicle from a history of parking events associated with the vehicle and employing those preferences in processing a reservation.

Another aspect of some embodiments of the invention relates to provision of an alternate specific parking spot when there is a problem with an initially assigned parking spot. In some embodiments the problem is that the initially assigned spot is occupied by another car. In other exemplary embodiments of the invention, the problem is a physical impediment to use other than a parked car (e.g. fallen tree, garbage dumpster, standing water or snow).

It will be appreciated that the various aspects described above relate to solution of technical problems associated with traffic congestion resulting from cars searching for parking spots.

Alternatively or additionally, it will be appreciated that the various aspects described above relate to solution of technical problems related to inefficient use of available parking spots.

Alternatively or additionally, it will be appreciated that the various aspects described above relate to solution of technical problems related to appropriate allocation of spots for special purposes (for example, deliveries).

Alternatively or additionally, it will be appreciated that the various aspects described above relate to solution of technical problems related to sign deployment and maintenance.

Alternatively or additionally, it will be appreciated that the various aspects described above relate to solution of technical problems related to changes in parking rules, for example, for special events.

In some exemplary embodiments of the invention there is provided a system including a database of individual on-street parking spots, and individual off-street parking spots, each of the individual parking spots associated with a unique identifier (UID) and location coordinates; and an off street spot management module in communication one or more external client devices, adapted to receive parking rules from an external client device operated by an owner of each of the individual off-street parking spots. In some embodiments the system includes a location definition module adapted to receive location coordinates defining a specific individual off-street parking spot from one of the one or more external client devices, assign a UID to the location coordinates to create an individual spot definition and add the spot definition to a spot database. Alternatively or additionally in some embodiments the system includes a cue management module adapted to receive cue information to be used in guiding a vehicle to a specific individual off-street parking spot and associate the cue information with the specific spot in a spot database. Alternatively or additionally in some embodiments of the system, the off street spot management module resides on a reservation server. Alternatively or additionally in some embodiments of the system, the off street spot management module resides on an external client device adapted to communicate with a reservation server. Alternatively or additionally in some embodiments of the system, at least some of the individual off-street parking spots are privately owned.

In some exemplary embodiments of the invention there is provided a system including a database of individual parking spots, each of the individual parking spots associated with a unique identifier (UID) and location coordinates and a current availability status; a reservation management server adapted to receive user parking requests from user client devices, each request including a destination; a suggestion engine adapted to transmit prompts including hourly parking rate and distance from destination for parking spots to the user client devices at least until an order is received at the server from the user client device or the request is cancelled by the user client device; and a reservation engine that transforms the order into a reservation by changing an availability status of an ordered spot to not available. In some embodiments of the system, the suggestion engine continues to transmit additional prompts after the order is received; each additional prompt having a shorter distance to destination and/or a lower hourly parking rate than the order; and wherein the reservation engine transforms a new order into a reservation and cancels a previous order received from a same user client device upon selection of one of the additional prompts from the user client device. Alternatively or additionally in some embodiments, the system includes a cancellation management module adapted to receive cancellation requests from a user client device, and cancel a previous request or order made by the user client device. Alternatively or additionally in some embodiments of the system, the prompts include additional information. Alternatively or additionally in some embodiments of the system, the additional prompts indicate individual spots which were not available when the parking request was received.

In some exemplary embodiments of the invention there is provided a system including a database of individual parking spots, each of the individual parking spots associated with a unique identifier (UID) and location coordinates and a current availability status; a reservation management server adapted to receive user parking requests from user client devices coupled to a position tracker via a network, each request including a destination; a tracking engine monitoring progress of each position tracker towards the destination defined in the request from the client device coupled thereto and issuing a push signal when a threshold proximity to destination is crossed; and a suggestion engine responding to the push signal by transmitting a location of at least one individual parking spot to the user client device as a spot suggestion. In some embodiments of the system, the suggestion engine transmits only one spot suggestion and reservation management server transforms the suggestion to a reservation. Alternatively or additionally in some embodiments the system includes a user profile, wherein the suggestion engine chooses the one spot based on the user profile. Alternatively or additionally in some embodiments of the system, the suggestion engine transmits several spot suggestions to the user client device and a choice is received at the reservation management server from the user client device. Alternatively or additionally in some embodiments of the system, the threshold is defined in in terms of distance from destination. Alternatively or additionally in some embodiments of the system, the threshold is defined in in terms of estimated arrival time. Alternatively or additionally in some embodiments of the system, the threshold includes maximum speed as second variable.

In some exemplary embodiments of the invention there is provided a method including receiving at a reservation management server from a user client device a bulk parking order for a future time, the bulk parking order defining a number of spots required, a desired parking duration, a start time, destination and a maximum distance therefrom; responding to the bulk parking order by transmitting a map of available parking spots at the future time for the desired parking duration from the start time and within the maximum distance from the destination to the user client device; receiving at the reservation management server an order indicating specific spots on the map and transforming the bulk parking order to a bulk parking reservation for the indicated spots. In some embodiments the method includes returning to the user client device a redemption token. Alternatively or additionally in some embodiments of the method, a maximum amount of time in the future the bulk parking order can be made varies as a function of the number of spots defined by the order. Alternatively or additionally in some embodiments the method includes providing an invitation redemption portal adapted to assign specific vehicle registration numbers to the specific spots defined in the bulk parking reservation.

In some exemplary embodiments of the invention there is provided a method including receiving, at a reservation management server, a query including location coordinates from a tracking component in a user client device equipped with a display; responding to the query by transmitting a portion of a map including the location coordinates, the map depicting parking spots and indicating for each spot whether its current status in the system is occupied, empty or reserved; the map displayable on the display. In some embodiments the method includes displaying a vehicle registration number of car that ordered a spot for each spot indicated as reserved on the map. Alternatively or additionally in some embodiments the method includes populating the spots on the map indicated as occupied with virtual reality depictions of relevant cars. Alternatively or additionally in some embodiments the method includes populating the spots on the map indicated as reserved with virtual reality depictions of relevant cars. Alternatively or additionally in some embodiments the method includes displaying text describing relevant cars in association with the spots on the map indicated as occupied. Alternatively or additionally in some embodiments the method includes presenting the map on the user client device in perspective view. Alternatively or additionally in some embodiments the method includes updating the map as the location coordinates of the user client device change. Alternatively or additionally in some embodiments the method includes updating the map as the current status of one or more spots changes. Alternatively or additionally in some embodiments the method includes receiving at the reservation management server a status change input from the user client device and updating a status of the spot in accord with the input. Alternatively or additionally in some embodiments of the method, the input switches a status of an individual spot to occupied. Alternatively or additionally in some embodiments of the method, the input switches a status of an individual spot from occupied to vacant.

In some exemplary embodiments of the invention there is provided a method including transmitting location information for a specific parking spot from a parking reservation management server to a user client device; and transmitting supplementary context information about the specific parking spot from the server to the user client device. In some embodiments of the method, the supplementary context information includes location information. Alternatively or additionally in some embodiments the method includes monitoring proximity of the user client device to the specific spot and transmitting the supplementary context information when a proximity threshold is crossed. Alternatively or additionally in some embodiments of the method, the supplementary context information describes a car in at least one flanking spot. Alternatively or additionally in some embodiments of the method, the supplementary context information describes an off street landmark. Alternatively or additionally in some embodiments of the method, the supplementary context information is provided as text. Alternatively or additionally in some embodiments of the method, the supplementary context information is provided as audio. Alternatively or additionally in some embodiments of the method, the supplementary context information is provided as a virtual reality representation of car currently parked in at least one flanking spot. Alternatively or additionally in some embodiments, the method includes providing navigation instructions to the location defined by the location information.

In some exemplary embodiments of the invention there is provided a parking kiosk including a user interface component accepting a vehicle registration number as an input; a request generator that that transmits the vehicle registration number to a parking reservation management server which assigns a specific parking spot to the vehicle registration number and generates a digital file encoding a map including navigation cues from the kiosk to the assigned spot and transmits the digital file back to the kiosk; and a map delivery apparatus. In some embodiments of the kiosk, the map delivery apparatus includes a printer that prints out the map encoded by the digital file. Alternatively or additionally in some embodiments of the kiosk, the map delivery apparatus includes a data port for transmission of the map to an external device. Alternatively or additionally in some embodiments the kiosk includes a camera positioned to capture an image of a user of the user interface component. Alternatively or additionally in some embodiments of the kiosk, the user interface component of kiosk accepts confirmation of parking and/or exit. Alternatively or additionally in some embodiments the kiosk includes a payment mechanism. Alternatively or additionally in some embodiments, the kiosk is connected to a server via a wired network connection. In some exemplary embodiments of the invention there is provided a method including receiving a request to park a vehicle at a reservation management server from a user client device; determining attributes of the vehicle; and searching a spot DB to identify spots with features corresponding to the vehicle attributes. In some embodiments of the method, the request includes a vehicle identification number and the determining includes retrieval of data from a vehicle DB. Alternatively or additionally in some embodiments of the method, the request includes a user identification and the determining includes retrieval of a user profile including attributes of the vehicle. Alternatively or additionally in some embodiments of the method, the vehicle attributes include physical characteristics. Alternatively or additionally in some embodiments of the method, the vehicle attributes include status characteristics. Alternatively or additionally in some embodiments of the method, the request includes a destination. Alternatively or additionally in some embodiments of the method, the request includes a user preference.

In some exemplary embodiments of the invention there is provided a method including receiving at a reservation management server a request to park including a destination from a user client device; compiling a list of available spots ahead of the user client device based on a current position and available travel direction of the user client device; and transmitting at least position coordinates of least one spot on the list to the user client device.

In some exemplary embodiments of the invention there is provided a method including receiving at a reservation management server a request to park from a user client device, the request including a destination; determining a category for the destination; and transmitting to the user client device a set of suggested parking spots including at least one parking spot at an alternate destination in the destination category. In some embodiments of the method, the determining includes a keyword analysis of the destination. Alternatively or additionally in some embodiments of the method, the destination includes a street address and the determining includes a query to a directory to determine what is at the address. Alternatively or additionally in some embodiments of the method, each parking spot in the set of suggested parking spots is characterized in terms of estimated wait time for availability.

In some exemplary embodiments of the invention there is provided a method—including receiving a parking request including a destination at a reservation management server; and transmitting a prompt to accept assignment to a spot in proximity to public transportation hub to a user client device from which the request originated. Alternatively or additionally in some embodiments the method includes analyzing the request to determine whether a stop for any public transportation route proving service from the hub is in proximity to the destination. Alternatively or additionally in some embodiments of the method includes including in the prompt information on how much closer to the destination the stop is than the available parking spot closest to the destination. Alternatively or additionally in some embodiments the method includes including in the prompt information on how much money is potentially saved by using public transportation from the hub. Alternatively or additionally in some embodiments the method includes including in the prompt information on how much time is potentially saved by using public transportation from the hub.

In some exemplary embodiments of the invention there is provided a method including receiving a parking request including a vehicle registration number at a parking reservation server; accessing parking history for the vehicle registration number; identifying at least one parking preference in the history; and transmitting one or more suggested parking spots to a user client device, accompanied by data pertaining to each identified preference for each spot. In some embodiments of the method, the request includes a destination. Alternatively or additionally in some embodiments of the method, the transmitting is of a single parking spot reserved for the vehicle registration number. Alternatively or additionally in some embodiments of the method, the parking history includes duration of previous parking events for the destination. Alternatively or additionally in some embodiments of the method, the history includes destinations defined for previous parking events. Alternatively or additionally in some embodiments the method includes constructing a user profile based on the at least one preference.

In some exemplary embodiments of the invention there is provided a method including transmitting a reservation for an initial parking spot to a user client device from a reservation management server in response to a parking request; receiving a problem notification related to the initial parking spot from the user client device at the server; and responding to the problem notification by transmitting a reservation for an alternate parking spot to the user client device. In some embodiments the method includes dispatching a service resource to the initial parking spot to evaluate the problem notification. Alternatively or additionally in some embodiments the method includes suspending further reservations for the initial parking spot until a problem of the problem notification is resolved.

In some exemplary embodiments of the invention there is provided a method including receiving a parking request from a first user client device at a reservation management server; storing a reservation of a parking spot in response to the request; receiving a request for details of the reservation from a second user client device. In some embodiments the method includes receiving a confirmation of parking in a spot reserved by the reservation. Alternatively or additionally in some embodiments the method includes receiving an exit notification for the parking spot.

In some exemplary embodiments of the invention there is provided a user client apparatus including a calendar reader that reviews entries in a digital calendar and prompts the user for confirmation that one or more future events presented in a list is a current destination and; a destination modification module that prompts the user for a parking reservation request and, upon confirmation issues the parking reservation request to a reservation management server via a network. In some embodiments the apparatus includes a mapping module displaying current position on a map based upon output from a tracking device in communication with an external navigation resource. Alternatively or additionally in some embodiments of the apparatus, the external navigation resource includes a GNSS system (Global Navigation Satellite System). Alternatively or additionally in some embodiments of the apparatus, the external navigation resource includes at least one network communication station.

Unless otherwise defined, all technical terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

Glossary

For purposes of this specification and the accompanying claims the term “Region” indicates any geographical area having any or all types of parking facilities. “City” is used interchangeably with “region” unless specified otherwise.

For purposes of this specification and the accompanying claims, unless specified otherwise, the term “parking spot” or “spot” includes, for example, on-street, off-street, parking lots, garages (for example, multi-story parking towers and/or underground garages).

For purposes of this specification and the accompanying claims, unless specified otherwise, the term “venue” indicates a destination which attracts a large number of vehicles carrying occupants that share a common purpose. Examples of venues include football stadia, amusement parks, transportation hubs such as, for example, airports and train stations, and shopping malls.

For purposes of this specification and the accompanying claims, unless specified otherwise, the term “vehicle attribute” indicates either one or both technical data of the vehicle and legal status.

“Technical data” includes, but is not limited to physical dimensions (length, width and height), and engine type (powered by gasoline, hydrogen; liquid propane or electricity).

“Legal status” includes, but is not limited to, private, resident (for example, of a specific region or a specific parking zone defined within that region) emergency (for example, fire truck or ambulance), law enforcement, government (for example, municipal maintenance trucks, postal delivery vehicles), security, diplomatic, delivery, utility (for example, phone company or electric company).

For purposes of this specification and the accompanying claims the term “vehicle” indicates any wheeled conveyance used for on or off road transportation, provided that the specified vehicle is susceptible of being uniquely identified by listing in a database. This definition includes, but is not limited to, automobiles, motorcycles, bicycles, tricycles, motorbikes/scooters, buses, trucks, emergency vehicles, security vehicles, industrial vehicles and public transportation vehicles.

For purposes of this specification and the accompanying claims the terms “driver” and “user” are used interchangeably to mean a vehicle operator or vehicle passenger or other individual interacting with the system for the purpose of reserving a parking spot for a specified vehicle.

For purposes of this specification and the accompanying claims terms such as “processing,” “computing,” “calculating,” “determining,” “analyzing” or the like, refer exclusively to the action and/or processes of a computer, computing system, client/server system, or similar electronic computing device that manipulates and/or transforms data. In some embodiments these verbs are indicative of a transformation of abstract data into a concrete representation of information that has utility outside the machine on which it resides.

For purposes of this specification and the accompanying claims the terms “transmitting” and “receiving”, or their conjugates, indicate network data transfer.

For purposes of this specification and the accompanying claims “database” is represented by the acronym DB.

For purposes of this specification and the accompanying claims “Command and Control Center” is represented by the acronym CCC.

For purposes of this specification and the accompanying claims the acronym “UI” indicates user interface and the acronym “GUI” indicates graphical user interface.

For purposes of this specification and the accompanying claims the acronym “UID” indicates unique identifier.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed device, system or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. for example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The accompanying figures are:

FIG. 1 is a schematic representation of a parking system according to some embodiments of the invention;

FIG. 2a is a schematic representation of an exemplary graphic user interface for selecting a specific parking spot from a list offered by a reservation management server, displayed on a user client device;

FIG. 2b is a schematic representation of an exemplary graphic user interface for confirming arrival at specific parking spot interface assigned by a reservation management server displayed on a user client device;

FIG. 2c is a schematic representation of an exemplary graphic user interface for confirming departure from a specific parking spot assigned by a reservation management server displayed on a user client device;

FIG. 3 is a schematic representation of a parking system according to some embodiments of the invention;

FIG. 4 is a schematic representation of a parking system according to additional embodiments of the invention;

FIG. 5 is a schematic representation of a parking system according to further additional embodiments of the invention;

FIG. 6 is a simplified flow diagram of a method according to some exemplary embodiments of the invention;

FIG. 7a is a simplified flow diagram of a method according to additional exemplary embodiments of the invention;

FIG. 7b is a schematic representation an exemplary user client device interface according to some exemplary embodiments of the invention;

FIG. 8a is a simplified flow diagram of a method according to further additional exemplary embodiments of the invention;

FIG. 8b is a schematic representation of an exemplary user client device interface for presenting context information for a specific spot;

FIG. 8c is a schematic representation of another exemplary user client device interface for presenting context information for a specific spot;

FIG. 9 is a schematic representation of a parking kiosk according to some embodiments of the invention;

FIG. 10 is a simplified flow diagram of a method according to still further additional exemplary embodiments of the invention;

FIG. 11 is a simplified flow diagram of a method according to still further additional exemplary embodiments of the invention;

FIG. 12 is a simplified flow diagram of a method according to still further additional exemplary embodiments of the invention;

FIG. 13a is a simplified flow diagram of a method according to still further additional exemplary embodiments of the invention;

FIG. 13b is a schematic representation of information flow according to some exemplary embodiments of the invention;

FIG. 14 is a simplified flow diagram of a method according to still further additional exemplary embodiments of the invention;

FIG. 15 is a simplified flow diagram of a method according to still further additional exemplary embodiments of the invention;

FIG. 16 is a table illustrating an exemplary rule application scheme according to some embodiments of the invention;

FIG. 17 is a simplified flow diagram of a method according to still further additional exemplary embodiments of the invention;

FIG. 18 is a schematic representation of a user client device according to some exemplary embodiments of the invention;

FIG. 19 is a schematic representation of a parking system according to some embodiments of the invention;

### DETAILED DESCRIPTION OF EMBODIMENTS

Embodiments of the invention relate to parking systems, methods and devices.

Specifically, some embodiments of the invention are used to assign a specific vehicle to a specific parking spot. In some embodiments the assignment is for a predetermined amount of time.

Alternatively or additionally, some embodiments of the invention are used to join two or more adjacent parking subunits to create a spot for a single vehicle (for example, a standard car, oversized or requiring extra clearance for a lift).

Alternatively or additionally, some embodiments of the invention are used to manage what were previously considered as separate parking resources (e.g., on street spots and/or off street lots or garages and/or individual privately owned-spots) as an integrated parking facility.

Alternatively or additionally, some embodiments of the invention are used to change parking rules from a central command and control center (CCC) easily and conveniently.

Alternatively or additionally, some embodiments of the invention are used to provide usage statistics to the CCC according to selected areas. According to various exemplary embodiments of the invention the statistics are presented as a function of time and/or price.

The principles and operation of systems and/or methods and/or devices according to exemplary embodiments of the invention may be better understood with reference to the drawings and accompanying descriptions.

Before describing at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of exemplification and should not be regarded as limiting.

System Overview

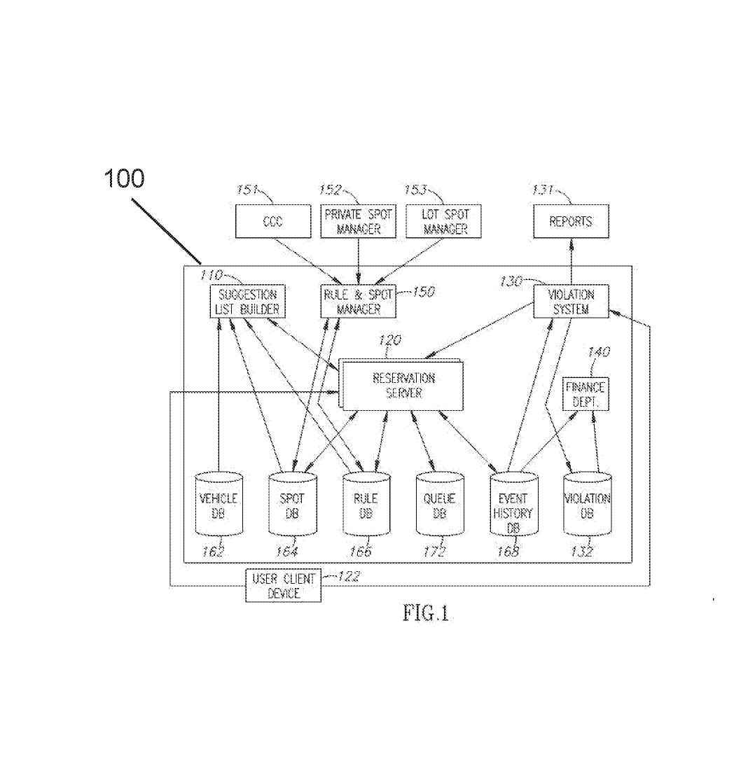

FIG. 1 is a schematic representation of a computerized parking system illustrating the context in which various embodiments operate, indicated generally as system 100. Sub-systems and related methods discussed in greater detail below may be easier to understand when considered in the context of system 100 as described here.

Referring now to FIG. 1, depicted exemplary system 100 operates a reservation server 120 which receives inputs from user client devices 122. A single user client device 122 is depicted for clarity although a much larger number will be present in actuality.

One main function of the system is to receive parking requests from user client devices 122. In one embodiment, the request entered by a user includes a vehicle registration number and an indication of a destination. Server 120 responds to each request by providing a reservation for a specific vehicle (e.g., identified by vehicle registration number) to a specific parking spot based upon a parking request from the user. In order to support this function, many embodiments of system 100 aid the operator of user client device 122 in locating and/or identifying the specific parking spot associated with their reservation.

Another main function of system 100 is to contribute to efficient enforcement of parking violations. One way that system 100 makes this contribution is by permitting user client devices 122 to report parking violations to a violation system 130.

According to various exemplary embodiments of the invention reservation server 120 communicates with one or more information resources to procure information needed to process an incoming parking reservation request from user client 122.

Exemplary databases (DBs) in system 100 are:

Vehicle DB 162, which stores vehicle attributes (as defined in Glossary hereinabove) in association with a vehicle registration number. In some embodiments at least a portion of the information in vehicle DB 162 is available from a governmental licensing authority (for example, department of motor vehicles, department of public safety or ministry of transportation). In some embodiments system 100 communicates with an external governmental DB during processing of each incoming reservation request. In some embodiments system 100 mirrors the external governmental DB. In some embodiments, mirroring contributes to processing speed of each incoming reservation request. Alternatively or additionally, system 100 provides supplemental information to DB 162 (for example, legal attributes associated with a vehicle) and/or an icon depicting the vehicle.

Parking spot DB 164 which stores information regarding the location (i.e. location coordinates), size and current status of parking subunits. Each parking spot (which may consist of several parking subunits) is administered by the system 100. Information regarding the location, size and current status of parking spots is also be stored in spot DB 164.

In some exemplary embodiments of the invention, each parking subunit and/or specific spot has a unique identifier (UID). In some embodiments the UID is visible to a user of the system when they park their car (for example, painted on the pavement or on a wall or a sign adjacent to the subunit(s) or spot). In some embodiments spot DB 164 also stores status for future time points (for example. if advance reservations are accepted and/or if the current use is subject to a time limitation). Typically spot DB 164 assigns a status of “available” or “not available” for each individual parking subunit as a function of time. The status “available” for a subunit indicates that it is not occupied and not reserved and not precluded from use by any rule. The status “not available” indicates that the spot is either occupied or reserved or precluded from use by a rule or “uncertain”. In some cases a temporary “uncertain” status is applied to spots and/or parking subunits which are the subject of complaints or reports. The “uncertain” status will only be maintained until the actual status is investigated (e.g., by dispatching system personnel to inspect the parking spot). In some embodiments sub statuses are applied, such as “reserved”, “occupied”, “in violation”.

Rule DB 166, which stores parking rules for each individual spot administered by the system. According to various exemplary embodiments of the invention, rule changes are applied to individual spots and/or groups of spots by one or more parties. As a result, multiple rules may apply to a given spot at any given moment. Alternatively or additionally, rules often have multiple attributes as described hereinbelow in the section entitled “Exemplary rule attributes”.

Queue DB 172, which stores incoming parking reservation requests that have not yet been transformed into reservations for a specific spot and/or reservations for a specific spot which have not yet been taken up by an assigned car parking in the assigned spot.

Event history DB 168, which stores “parking events” for a particular spot defined in terms of at least a vehicle registration number and a parking duration. In many embodiments details such as, for example, date, reservation time, time in, time out, specific parking spot and hourly rate are also stored. Periodically, events from event history DB 168 are sent from system 100 to finance department 140 for payment processing.

Violation history DB 132, which stores “violation events” defined in terms of at least a vehicle registration number and a specific spot. In many embodiments details such as, for example, date, time, infraction type (e.g., parked for 3 hours in a 2 hour spot or parked in a spot reserved for another vehicle) are stored. In some embodiments, evidence (e.g., a photograph of the infraction with a date/time stamp) is also stored in DB 132. Periodically, events from DB 132 are sent from system 100 to finance department 140 for payment processing.

In the depicted embodiment, reservation server 120 also communicates with suggestion list builder 110 to process at least some of the incoming parking reservation requests from user clients 122. Suggestion list builder 110, in turn, communicates with DBs 162, 164 and 166 to assemble a list of available spots in proximity to a destination defined in the request received from user client device 122 and suitable for the car defined by the vehicle registration number in the request.

Alternatively or additionally, in some embodiments reservation server 120 also communicates with violation system 130 and relays violation information to spot DB 164. According to various exemplary embodiments of the invention violation information includes discovery of an unauthorized vehicle in a specific spot and/or a report of removal by a law enforcement agency of an unauthorized vehicle from a specific spot. Both the discovery and the removal report result in a status change for the specific spot in question in DB 164. In some embodiments violation system 130 reports events which prevent the use of or access to a parking spot. Examples of such events include for example, a fallen tree or piles of snow resulting from plowing.

In some embodiments violation system 130 also issue reports 131 in the form of parking tickets.

In the depicted embodiment, system 100 includes a rule and spot manager 150 functioning to relay externally provided rules to spot DB 164. In the depicted embodiment externally supplied rules originate from a command and control center (CCC) 151 and/or from lot spot manager 153 and/or from private spot manager 152. Each of CCC 151, private spot manager 152 and lot spot manager 153 operate a rule input interface adapted to their specific needs. The rule input interface for CCC 151 is typically the most robust of the three. The rule input interface for CCC 151 handles the largest number of spots and deals with the largest number of possibilities. The rule input interface for lot spot manager 153 is typically intermediate in capacity. For example, the rule input interface for lot spot manager 153 may deal primarily with rules applicable to a whole parking facility, or a whole floor within a parking facility. The rule input interface for private spot manager 152 typically has the least capacity. Private spot manager 152 deals with rules for a single spot.

Exemplary Single Parking Reservation Request

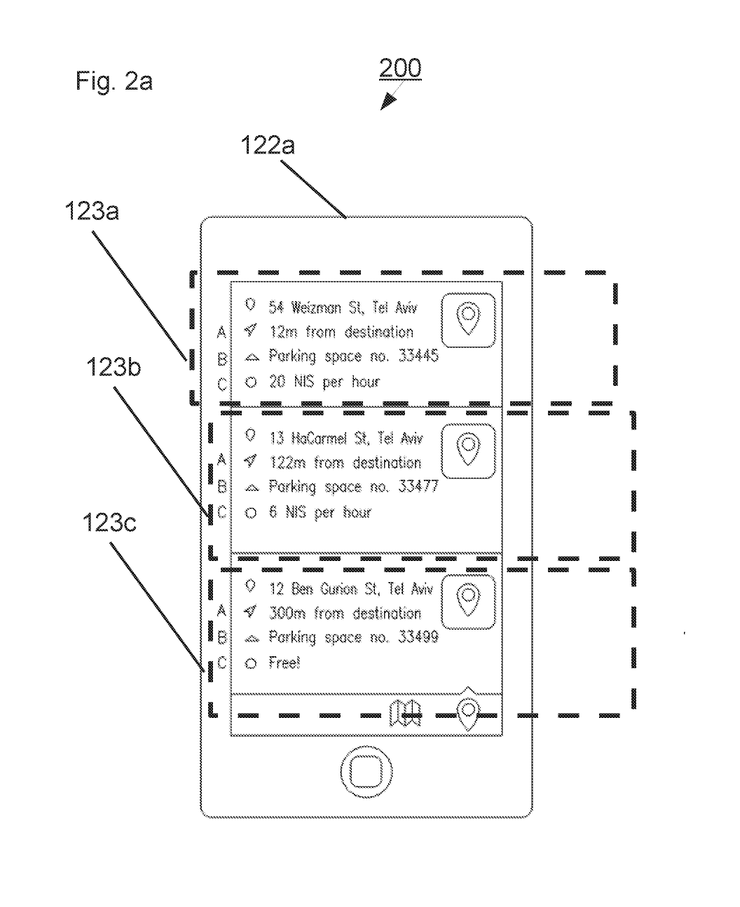

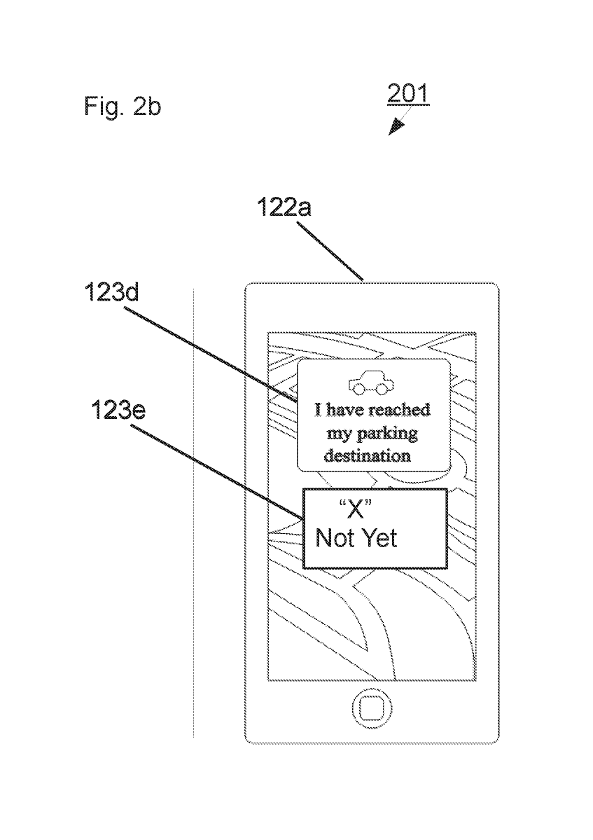

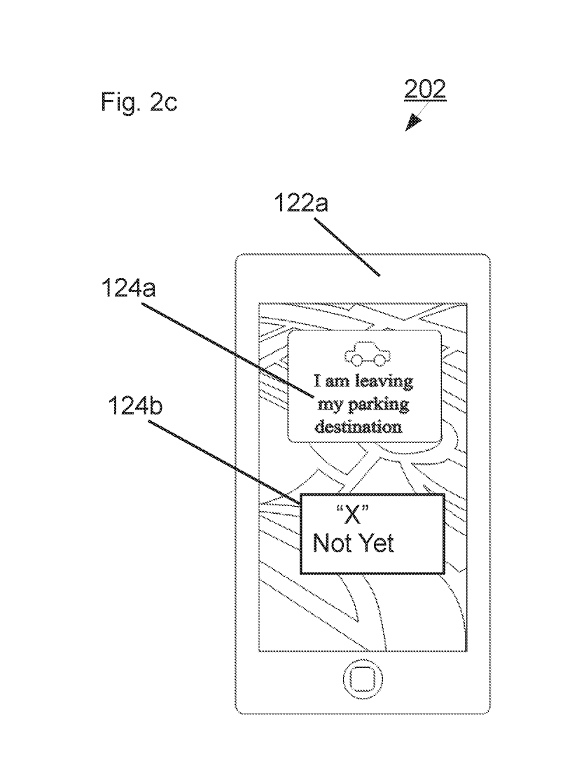

As an example of how system 100 works, the processing of a single reservation request, which defined 52 Weizman St. in Tel Aviv as a destination, is described with respect to both the functionalities of system 100 (FIG. 1) and of a specific user client device 122a (FIGS. 2a-2c) in the form of a smart phone running a software application (“app” or “parking app”) that serves as a communication interface between system 100 and the display of device 122a. According to various exemplary embodiments of the invention, the vehicle registration number is either included in the request or is available to the system from a user profile established previously (For example, during installation of the app).

Reservation server 120 of system 100 (FIG. 1) receives the request and relays it to suggestion list builder 110. List builder 110 analyzes information in DBs 162, 164 and 166 and assembles a list of available parking spots that are relevant to the specific request. According to various exemplary embodiments of the invention relevance is analyzed either according to a user profile and/or according to rules programmed into list builder 110. The list of available parking spots is relayed to user client device 122a via reservation server 120.

FIG. 2a is a schematic representation 200 of an exemplary user client device 122a displaying a user interface for selecting a specific parking spot from a list offered by reservation management server 120 after construction by list builder 110. In the depicted embodiment each of list items 123a, 123b and 123c includes a street address, a distance from the requested destination and an hourly rate. An operator of device 122a makes a selection by touching one of the items in the list or by issuing a voice command.

In some embodiments selection of a list item issues an instruction to a navigation app running on user client device 122a and the navigation app guides the operator of 122a to a specific parking spot using location coordinates associated with the item selected from the list (but typically not displayed on the screen).

FIG. 2b is a schematic representation 201 of user client device 122a displaying an exemplary interface for confirming arrival at a specific parking spot assigned by reservation management server 120 (FIG. 1) overlaid on the map of the navigation app. Since the navigation app is aware of current location and speed (for example, from a tracking component installed in device 122a), in some embodiments the navigation app displays a prompt 123d to confirm parking as the vehicle approaches the spot and/or slows down in proximity to the spot. The user confirms as described above for selection of a list item. In the depicted embodiment, a “do not confirm” icon 123e is also provided. Upon receipt of confirmation of parking at server 120, the server updates the sub-status of the specific spot and/or of the parking subunits comprising the spot in DB 164 from “reserved” to “occupied”.

FIG. 2c is a schematic 202 of user client device 122a displaying an exemplary interface for confirming departure from a specific parking spot assigned by a reservation management server 120. Since the navigation app is aware of current location and speed (for example, from a tracking component installed in the device), the navigation app displays a prompt 124a to confirm exit from the parking spot as the vehicle departs from the spot and/or attains a velocity that indicates the operator of the device is not on foot (for example, 25 km/hr). The user of the device confirms as described above for selection of a list item. In the depicted embodiment a “do not confirm” icon 124b is also provided. Upon receipt of confirmation of exit from the parking spot at server 120, the server 120 updates the sub-status of the specific spot and/or the parking subunits comprising the spot) in DB 164 from “occupied” to “unoccupied” or “reserved” as appropriate.

This simplified example does not demonstrate the full range of capabilities of system 100.

First Exemplary System

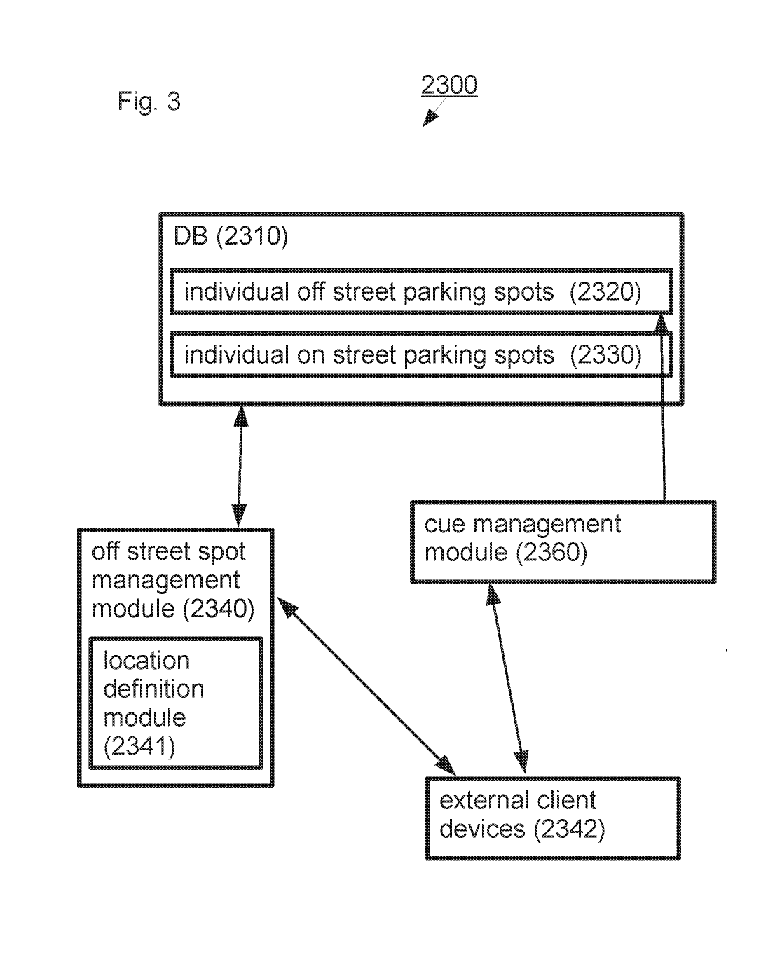

FIG. 3 is a schematic representation of a computerized parking management system, indicated generally as 2300, according to some embodiments of the invention. Depicted exemplary system 2300 includes a database 2310 of individual on-street parking spots 2330 and individual off-street parking spots 2320, each of the individual parking spots associated with a unique identifier (UID) and location coordinates. The depicted system also includes an off street spot management module 2340 in communication one or more external client devices 2342 and adapted to receive parking rules from an external client device 2342 operated by an owner of each of the individual off-street parking spots. The term “external client” indicates spot management function but the client devices can be any of the device types listed in the section entitled “Exemplary user client devices”.

In some embodiments system 2300 includes a location definition module 2341 (depicted here as part of spot management module 2340) adapted to receive location coordinates defining a specific individual off-street parking spot from one external client devices 2342 and assign a UID to the location coordinates to create an individual spot definition and add the spot definition to spot database 2310. For example, in some embodiments an owner of an individual off street spot uses a location function of a smartphone to acquire and transmit location coordinates of a specific parking spot to module 2341.

In the depicted embodiment, system 2300 includes a cue management module 2360 adapted to receive cue information from the external client device 2342. The cue information is used in guiding a vehicle to a specific individual off-street parking spot. The cue information transmitted from client device 2342 to module 2360 is stored in DB 2310 in association with a specific off street spot 2320 in the DB 2310. According to various exemplary embodiments of the invention cue information includes audio and/or text and/or images. Although modules 2341 and 2360 are depicted separately for clarity, the functions of both are incorporated into a single module in some embodiments.

In some embodiments off street spot management module 2340 resides on reservation server 120 (FIG. 1). According to these embodiments, owners of off street spots log in and have access privileges only for spots they own.

In some embodiments off street spot management module 2340 resides on an external client device 2342 adapted to communicate with reservation server 120. According to these embodiments, spot owners manage their spots on the external client (using any device 2342) and submit rules to reservation server 120. Parking lot owners can manage their spots on an individual basis (for example a single spot subscription sold by lot equals a “reservation blackout” for the system), in groups (for example lease of a whole floor of a parking garage to a company) or on a whole lot basis (for example a global rate change).

In some embodiments at least some of individual off street parking spots 2320 are privately owned.

Different on-street and/or different off-street parking spots may be owned by different owners. Systems and methods according to embodiments of the invention enables centralized control of different types of parking spots regardless of ownership.

Second Exemplary System

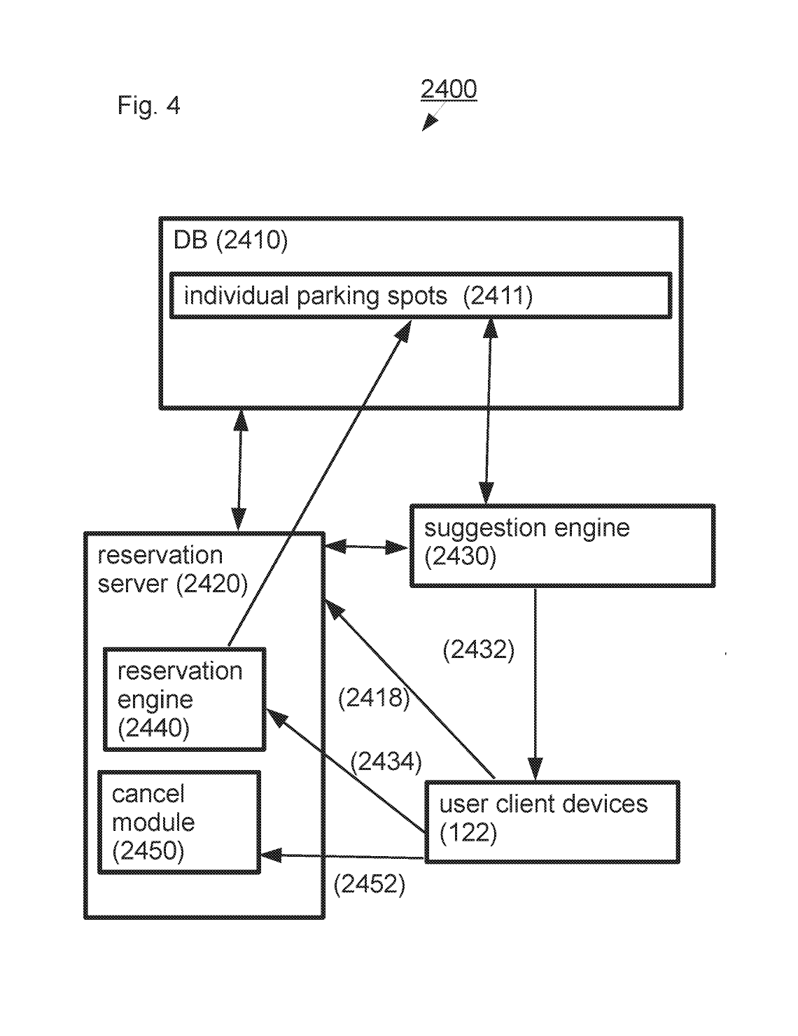

FIG. 4 is a schematic representation of a computerized parking management system, indicated generally as 2400 according to some embodiments of the invention. Depicted exemplary system 2400 includes a database 2410 of individual parking spots 2411 with each of the individual parking spots associated with a unique identifier (UID) and location coordinates and a current availability status. In the depicted embodiment a reservation management server 2420 receives user parking requests 2418 from user client devices 122 with each request including a destination.

In the depicted embodiment suggestion engine 2430 transmits prompts 2432 including hourly parking rate and distance from destination for parking spots to user client devices 122 at least until an order 2434 is received at engine 2440 of server 2420 from said user client device 122 or until request 2418 is cancelled 2452 by user client device 122.

Depicted reservation engine 2440 transforms order 2434 into a reservation by changing an availability status of an ordered spot to not available in DB 2410.

In some embodiments suggestion engine 2430 continues to transmit additional prompts 2432 after order 2434 is received. According to these embodiments each additional prompt 2432 offers a spot that has better conditions (for example a shorter distance to destination and/or a lower hourly parking rate) than the spot requested in order 2434. According to these embodiments, reservation engine 2440 transforms new order 2434 into a reservation and cancels a previous order received from a same user client device 122 upon selection of one of additional prompts 2432 from the suggestion engine 2430.

In the depicted embodiment system 2400 includes a cancellation management module 2450 adapted to receive cancellation requests 2452 from a user client device 122, and cancel a previous request 2418 or order 2434 made by the user client device. In some embodiments cancellation management module 2450 cancels a previous request 2418 (or order 2434) sent from the same user client device 122 from which the previous request 2418 (or order 2434) was sent. In other embodiments a cancellation request 2452 is made from a different user client device 122 and is accompanied by information connecting the cancellation request 2452 with the previous request 2418 (or order 2434). Examples of connecting information include, but are not limited to, a vehicle identification number, a user ID and/or password and identifying information for user client device 122 that made the reservation or order (for example a mobile phone number).

In some embodiments prompts 2432 include additional information. Examples of additional information for inclusion in a prompt include, but are not limited to, on street/off street and/or parallel vs diagonal spot and/or indoor vs outdoor parking. In some embodiments for indoor parking a level within a parking facility is specified in the prompt.

Alternatively or additionally, in some embodiments additional prompts 2432 indicate individual spots which were not available when parking request 2418 was received at server 2420. In some embodiments these newly available spots are offered to the earliest request first (first in first out). Alternatively or additionally, in some embodiments these newly available spots are offered to the request with a destination closest to the newly available spot.

Exemplary Location Based Spot Suggestions

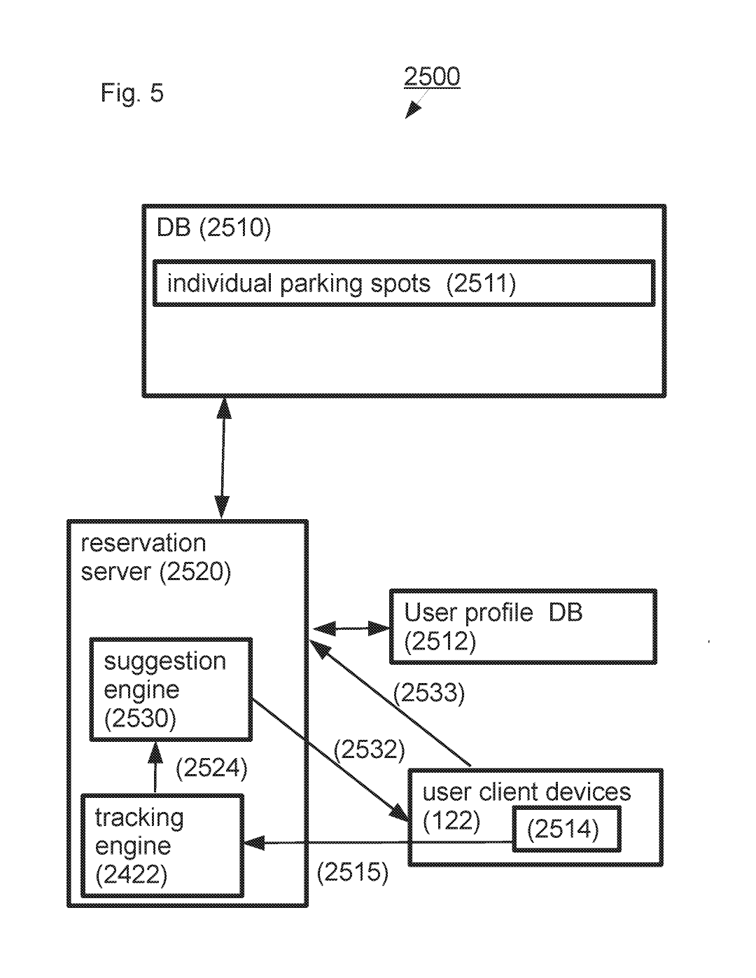

FIG. 5 is a schematic representation of a computerized parking management system, indicated generally as 2500 according to further additional embodiments of the invention. Depicted exemplary system 2500 includes a database 2510 of individual parking spots 2511 each of the individual parking spots associated with a unique identifier (UID) and location coordinates and a current availability status. In the depicted embodiment a reservation management server 2520 receives user parking requests 2515 from user client devices 122 that are coupled to position trackers 2514. In some exemplary embodiments of the invention, requests 2515 are compared to a user profile in a user profile DB 2512. In some exemplary embodiments of the invention, requests 2515 are received via a network and each request includes a destination. In some embodiments a tracking engine 2522 monitors progress of each position tracker 2514 towards the destination defined in request 2515 from client device 122 coupled thereto and issue a push signal 2524 when a threshold proximity to destination is crossed. In the depicted embodiment push signal 2524 is received by a suggestion engine 2530, which responds to the push signal 2524 by transmitting a location 2532 of at least one individual parking spot to user client device 122.

In some embodiments suggestion engine 2530 transmits only one spot suggestion 2532 and reservation management server 2520 transforms suggestion 2532 to a reservation.

In some embodiments system 2500 includes a user profile and suggestion engine 2530 chooses the one spot based on a user profile. According to various exemplary embodiments of the invention the user profile is associated with user client device 122 and/or with a vehicle registration number contained in request 2515.

In other exemplary embodiments of the invention, suggestion engine 2530 transmits several spot suggestions 2532 to user client device 122 and a choice 2533 is received at reservation management server 2520 from user client device 122. In some embodiments if no choice is received, the first suggestion in the list becomes a default selection.

According to various exemplary embodiments of the invention the threshold proximity (see above) is defined in in terms of distance from destination and/or in terms of estimated arrival time. In some embodiments the threshold includes maximum speed as a second variable. According to these embodiments tracking engine monitors speed of user client device 122 using tracking device 2515. In some embodiments push signal 2524 is sent by tracking engine 2522 only if the measured speed is below a predefined maximum speed (for example 20, 15, 10 or 5 K.P.H. or lower or intermediate speeds). In some embodiments, use of maximum speed as a second variable contributes to a reduction in dangerous driver interaction with user client device 122 while their vehicle is at high speed.

Virtual Parking Lot on Demand

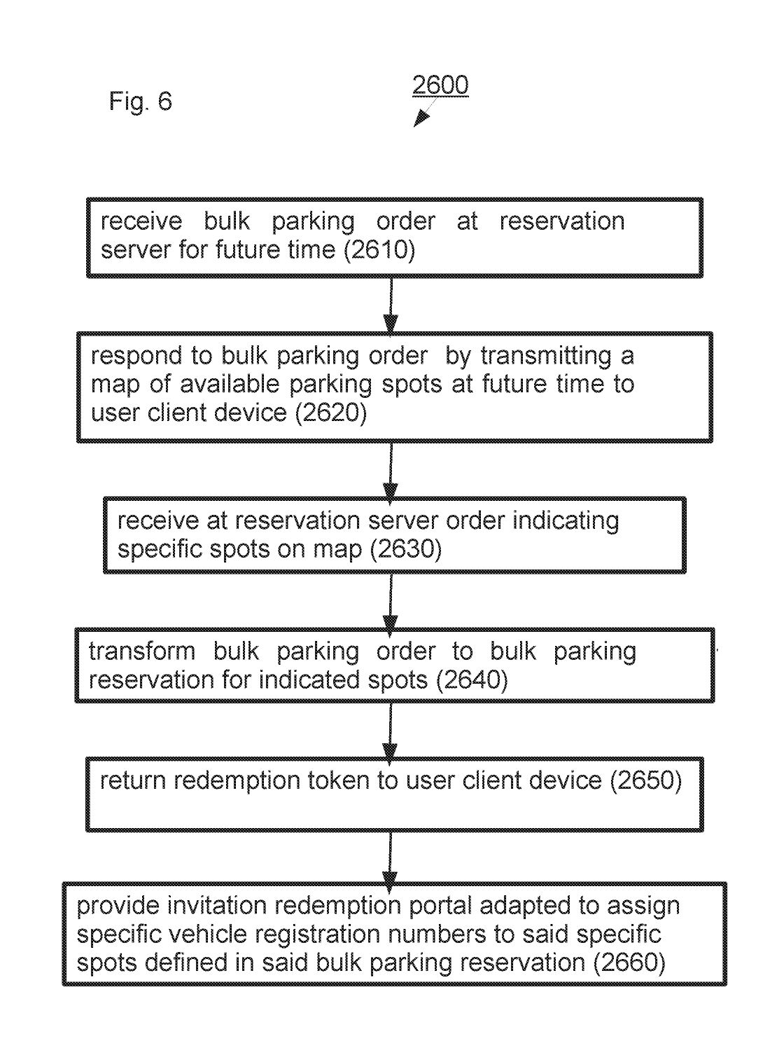

FIG. 6 is a simplified flow diagram of a method for providing a virtual parking lot on demand, indicated generally as 2600, according to some exemplary embodiments of the invention.

Depicted exemplary method 2600 includes receiving 2610 at a reservation management server from a user client device a bulk parking order for a future time. The bulk parking order defines a number of spots required, a desired parking duration, a start time, a destination and a maximum distance therefrom.

The depicted method includes the server responding 2620 to the bulk parking order by transmitting a map of available parking spots to the user client device. Each spot on the map is available at the future time for the desired parking duration from the indicated start time and is within the maximum distance from the destination

The depicted embodiment of method 2600 also includes receiving 2630 at the reservation management server an order indicating specific spots on the map and transforming 2640 the bulk parking order to a bulk parking reservation for the indicated spots at the future time.

In some embodiments the method includes returning 2650 a redemption token to the user client device. Exemplary redemption token formats include, but are not limited to hypertext links and/or QR codes and/or barcodes and/or an alphanumeric event codes. According to various exemplary embodiments of the invention the party placing the order distributes the redemption token to invitees in various ways. For example, in some embodiments QR codes are distributed on printed paper invitations for subsequent machine reading (for example using a camera of a smartphone as a reader). Alternatively or additionally, in some embodiments tokens are distributed to invitees as part of an e-invitation sent out by e-mail or using an instant messaging application. In some embodiments recipients of tokens use the redemption tokens to allocate a portion of the bulk parking order to a specific vehicle identification number and/or to obtain directions to a specific assigned spot.

In some embodiments a maximum amount of time in the future the bulk parking order can be made varies as a function of the number of spots defined by the order. For example, a system 100 accepts reservations further in advance as the number of spots involved goes up.

In the depicted embodiment the method includes providing 2660 an invitation redemption portal adapted to assign specific vehicle registration numbers to specific spots defined in the bulk parking reservation. According to various exemplary embodiments of the invention the portal is Internet based and/or provided as an IVR (Interactive voice response) menu at a call center and/or operates though a smartphone application.

Method 2600 is Described from the Client Side as Follows

(a) transmitting a bulk parking order for a future time across a network to a reservation management server from a user client device, the bulk parking order defining a number of spots required, a desired parking duration, a start time and a maximum distance of the spots from a defined location;

(b) receiving on a display of the user client device a map of available parking spots available at the future time for the desired parking duration from the start time and within the maximum distance from the defined location;

(c) transforming the bulk parking order to a bulk parking reservation by choosing specific spots on the map and transmitting the choices across the network to the reservation management server from the user client.

Alternatively or additionally, in some exemplary embodiments of the invention, responding 2620 includes provision of a non graphical UI (such as a list or table) by the server to the user in addition to or instead of the map and transmits it to the user.

Alternatively or additionally, in some embodiments, the user client device accepts user selections from a non graphical UI (such as a list or table) and/or displays user selections from a non graphical UI (such as a list or table). In some embodiments user selections made on a map appear in a list or table as part of a hybrid user interface.

Alternatively or additionally, in some embodiments selection made using a non graphical UI (such as a list or table) appear on a map as part of a hybrid user interface.

Exemplary Enforcement Method

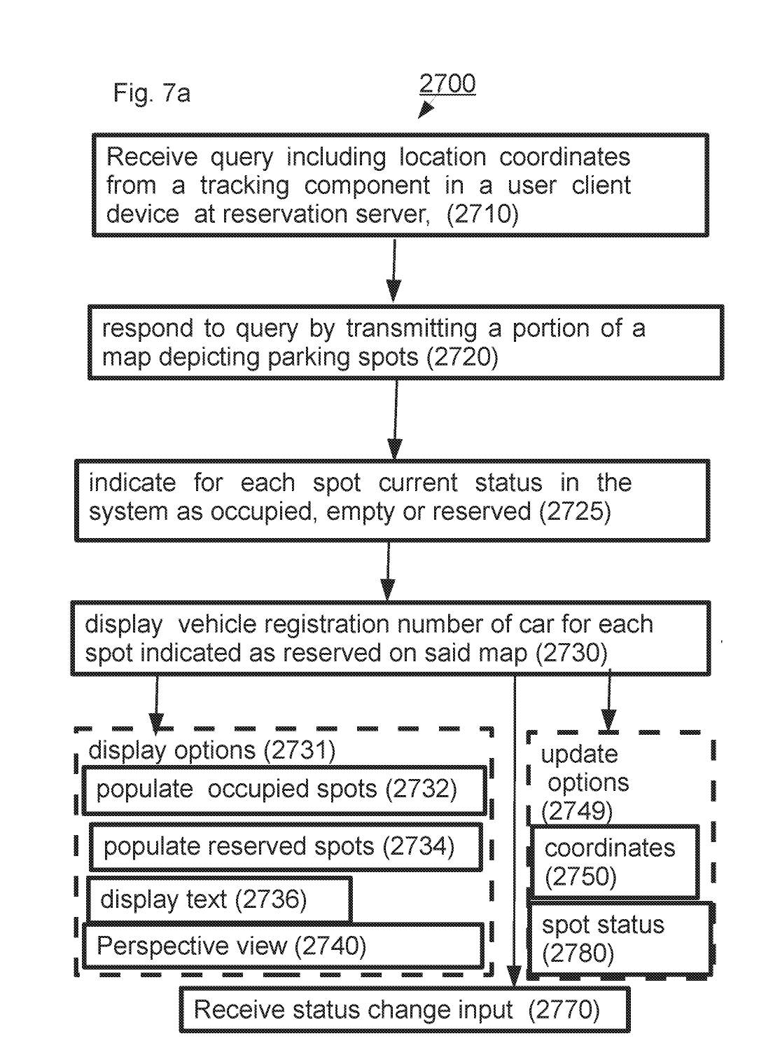

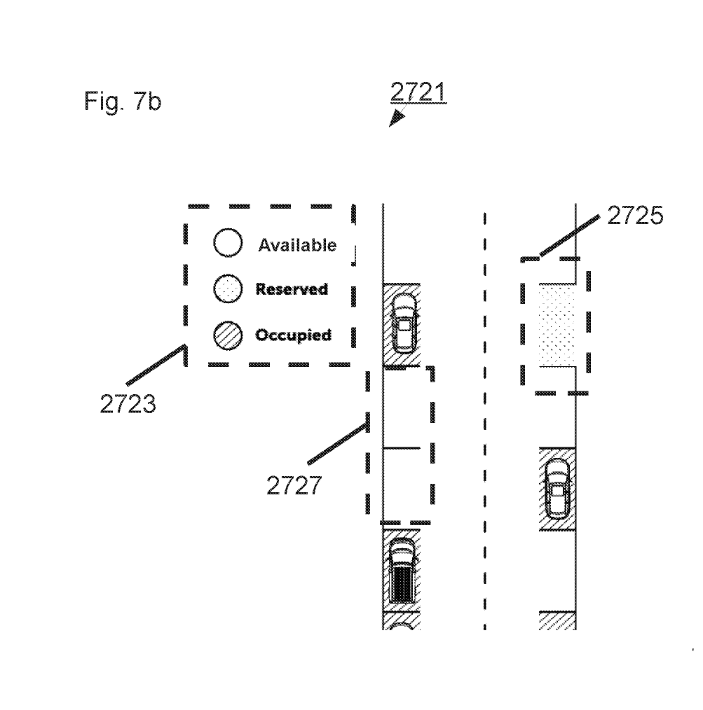

FIG. 7a is a simplified flow diagram of a method for parking enforcement, indicated generally as 2700, according to some exemplary embodiments of the invention.

Depicted exemplary method 2700 includes receiving 2710 at a reservation management server, a query including location coordinates from a tracking component in a user client device equipped with a display. In some embodiments the user client device is issued to a parking warden.

The depicted method includes responding 2720 to the query by transmitting a portion of a map including the location coordinates from the query. The map depicts parking spots and indicates 2725 for each spot whether its current status in the system is occupied, empty or reserved. The map is transmitted in a format suitable for display on the relevant user client device. In some embodiments map transmission is by allowing the user client device access to the system map online. In some embodiments a non-graphical UI (such as a list or table) is substituted for a map as described above in the context of FIG. 6a.

In some embodiments the method includes displaying 2730 a vehicle registration number of a vehicle specified in a reservation of a specific spot for each spot indicated as reserved on the map. According to various exemplary embodiments of the invention the display of the vehicle registration number is constant or appears in response to rollover and/or touch.

According to various exemplary embodiments of the invention the method includes one or more display options 2731 for the map.

In some embodiments the method includes populating 2732 spots on the map indicated as occupied with virtual reality depictions, or icons, of relevant cars.

Alternatively or additionally, in some embodiments the method includes populating 2734 the spots on the map indicated as reserved with virtual reality depictions, or icons, of relevant cars.

Alternatively or additionally, in some embodiments the method includes displaying 2736 text describing relevant cars in association with the spots on the map indicated as occupied and/or reserved. According to various exemplary embodiments of the invention the text includes make and/or model and/or color and/or vehicle registration number.

Alternatively or additionally, in some embodiments the method includes presenting 2740 the map on the user client device in perspective view. In some embodiments the perspective is that of a pedestrian at the location.

Alternatively or additionally, in some embodiments the method includes populating the spots on the map indicated as available with predetermined icons indicating this status.

Alternatively or additionally, according to various exemplary embodiments of the invention the method includes one or more update options 2749 for the map.

In some embodiments the method includes updating 2770 map as the location coordinates 2750 of the user client device change and/or updating spot status 2780. (See discussion of a user client device 122 equipped with a tracking device 2514 monitored by server via a tracking engine 2422 in the context of FIG. 5 above. In some embodiments this option is coupled with the presentation of perspective view 2740 and/or one or more other display options 2731.

Alternatively or additionally, in some embodiments the method includes updating 2780 the map as the current status of one or more spots changes.

Alternatively or additionally, in some embodiments method 2700 includes receiving at the reservation management server a status change input for a specific spot from the user client device and updating a status of the spot in a spot database in accord with the input. For example, in some embodiments a warden updates the system with respect to violations and/or cars that reserved but forgot to indicate arrival. According to these embodiments the input includes location coordinates and/or UID of spot and/or vehicle registration number. In some embodiments the input switches a status of an individual spot to occupied. For example, the status would be occupied if an authorized car is in a spot indicated as reserved or if the spot is illegally occupied. In some embodiments the system accepts a designation of “violation,” which indicates that the spot is occupied, and the system sends a report including a vehicle registration number to violation system 130 (FIG. 1). Alternatively or additionally, in some embodiments the input changes a status of an individual spot from occupied to vacant. For example, if a spot indicated as occupied on the map is empty.

FIG. 7b is a schematic representation of an exemplary user client device interface, indicated generally as 2721, for presenting status information for specific spots in proximity to a location. In the figure, key 2723 contributes to simplification of identification of reserved 2725 and/or available 2727 spots which are improperly occupied by a car. In this depiction no violations are shown. Interface 2721 is suitable for use in the practice of method 2700.

Exemplary Cue Pushing Method

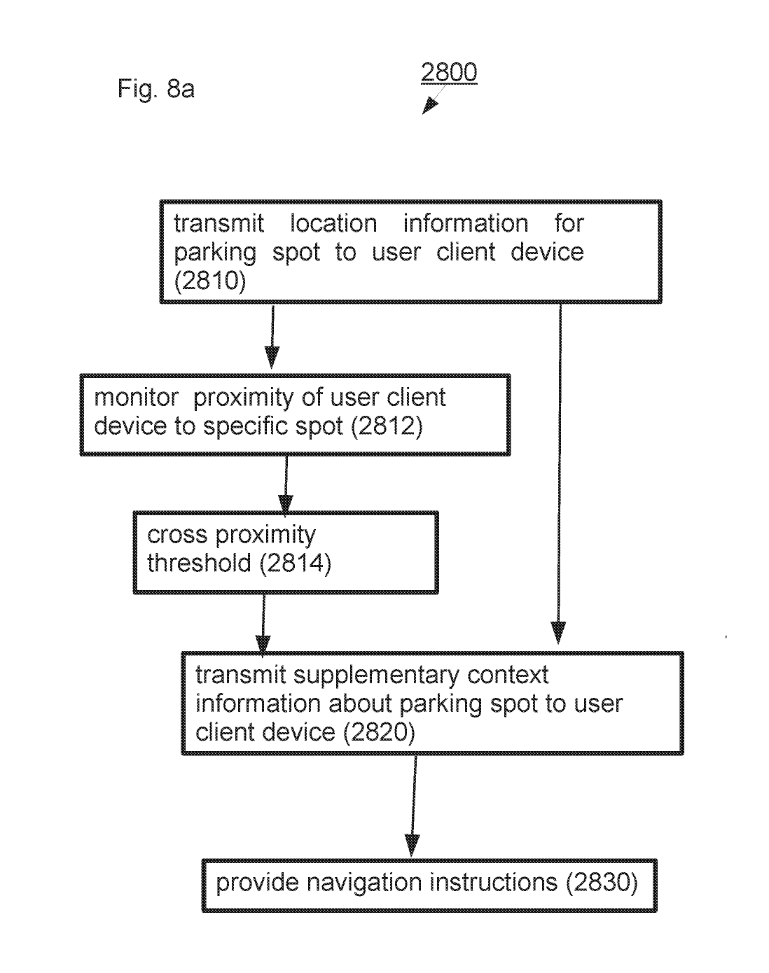

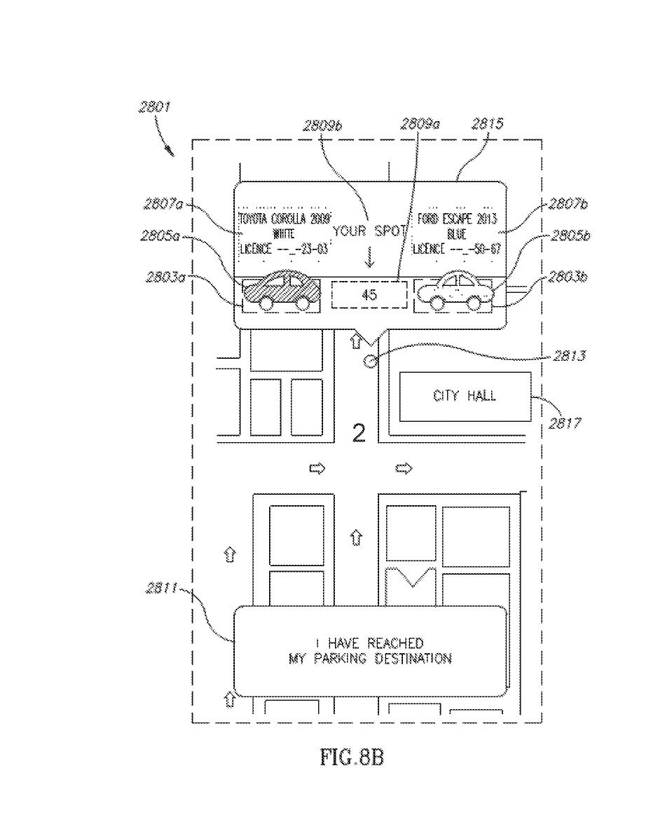

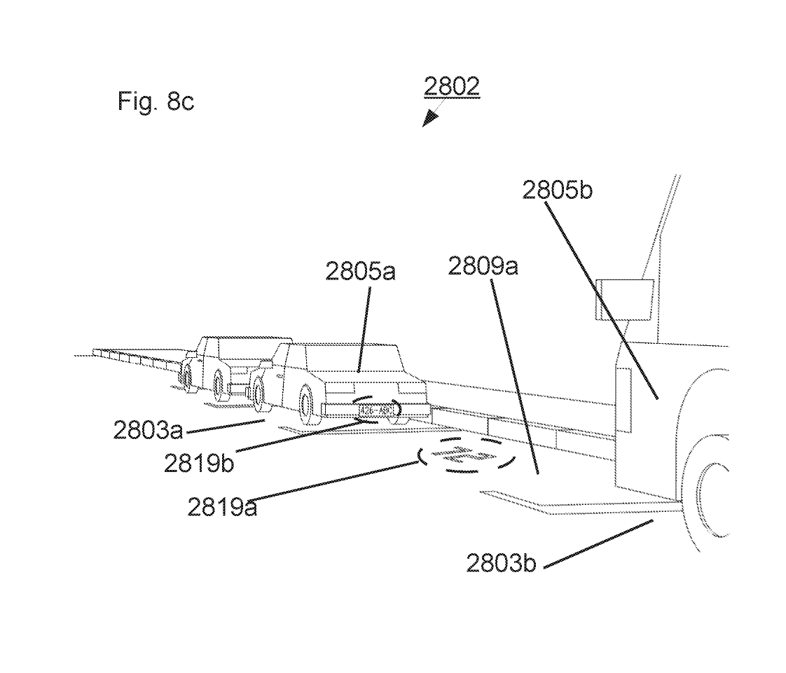

FIG. 8a is a simplified flow diagram of a computerized parking management method, indicated generally as 2800 according to some exemplary embodiments of the invention. Depicted exemplary method 2800 includes transmitting 2810 location information for a specific parking spot from a parking reservation management server to a user client device and transmitting 2820 supplementary context information (discussed below) about the specific parking spot from the server to the user client device. In some embodiments the location information transmitted at 2810 is in machine readable format (for example digitally encoded location coordinates). In some embodiments method 2800 includes providing navigation instructions 2830 to the location defined by the location information of 2810.

In some cases accuracy of a tracking or guidance component in the user client device is limited. For example, GPS tracking and navigation can have an error of +10 meters. The supplementary context information helps user easily and correctly identify a specific spot reserved for them if they are within sight range of the spot.

In some embodiments the supplementary context information includes location information. Although this location information is transmitted digitally in some embodiments, presentation on the user client device is in a non-machine readable format. For example, this additional location information is, in various embodiments, formatted as a street address and/or a row and spot number in a parking lot or garage. In some embodiments garage spots are further identified by level number and/or zone information (for example color and/or icon).

Some embodiments of depicted exemplary method 2800 include monitoring 2812 proximity of the user client device to the specific spot and transmitting 2820 said supplementary context information when a proximity threshold to the spot is crossed 2814.

FIG. 8b is a schematic representation of an exemplary user client device interface, indicated generally as 2801, for presenting context information for a specific spot assigned by the system. In some exemplary embodiments of the invention, interface 2801 is presented in a conventional vehicle navigation system. In many embodiments, the vehicle navigation system uses machine readable location information provided from 2810 (FIG. 8a) to guide the vehicle to the specific spot. According to various exemplary embodiments of the invention machine readable information includes location coordinates transmitted directly to a user client device for use by an application already running on that device and/or an instruction which, when read by a user client device, launches an application on the user client device and provides access to relevant position coordinates to the newly launched application. Examples of suitable machine readable information formats include QR codes and/or barcodes and/or hypertext links.

In some embodiments of depicted exemplary method 2800 the supplementary context information transmitted at 2820 describes a vehicle in at least one spot flanking the spot for which location information was provided at 2810.

Exemplary user interface 2801 includes a portion of a map with an assigned parking spot 2813, which is the destination indicated. In the depicted embodiment a pop up window 2815 displays the supplementary context information of 2820.

In the depicted embodiment some of the supplementary context information is provided in text boxes 2807a and 2807b. Each of text boxes 2807a and 2807b contains information describing cars 2805a and 2805b parked in spots 2803a and 2803b on either side of assigned spot 2809a indicated by marker 2809b. According to various exemplary embodiments of the invention the text in the text boxes 2807a and 2807b includes car make and/or car model and/or model year and/or color and/or at least a portion of the vehicle registration number (for example last 4 letters and/or numbers). As described hereinabove, this information is available from vehicle DB 162. In other exemplary embodiments of the invention, textual information is provided via a 2 G phone (for example via SMS message) and/or printed at a kiosk. Alternatively or additionally, supplementary context information depicted here as text is provided as audio (for example via a 2 G phone or on smart device). In some embodiments audio presentation employs text to speech technology in the relevant user client device.

In the depicted embodiment supplementary context information 2813 describes an off street landmark in the form of “City Hall” 2817. In the figure, the depiction is textual, but other embodiments employ graphics, an image or icon to represent off street landmarks. For example, an icon of a fire hydrant or a graphic of a sign (for example showing a name of a shop or restaurant and/or a symbol associated with a business) or a representation of a whole building (for example a photograph or icon).

Depicted exemplary interface 2801 includes a parking confirmation icon 2811. Selection of the icon (for example by touching on a touch screen user client device) transmits a signal to system 100 that spot 2813 indicated on the map is now occupied.

In some embodiments provision of supplementary context information about spot 2813 which is current contributes to an ability of a user of the system to find a specific spot assigned to them (e.g., information about currently parked vehicles received from vehicle DB 162). In some embodiments the supplementary context information is provided as a graphical and/or iconic and/or virtual reality representation of a car currently parked in at least one flanking spot.

FIG. 8c is a schematic representation of an exemplary user client device interface, indicated generally as 2802, for presenting context information for a specific spot assigned by the system. FIG. 8c is similar to FIG. 8b in content and purpose, but the perspective view of FIG. 8c imparts a feeling of virtual reality. In some embodiments 2802 is presented as a pop-p window, optionally layer over a portion of a map, as depicted in FIG. 8b. In some exemplary embodiments of the invention, interface 2802 is presented in a conventional vehicle navigation system. In many embodiments, the vehicle navigation system uses machine readable location information provided from 2810 (FIG. 8a) to guide the vehicle to the specific spot. In some embodiments of depicted exemplary method 2800 the supplementary context information transmitted at 2820 describes a vehicle (2805a and/or 2805b) in at least one spot flanking the spot (2803a and/or 2803b) for which location information was provided at 2810. In depicted user interface 2802 the supplementary context information is presented graphically in a perspective view simulating the viewpoint of a driver approaching the assigned spot 2809a.

In the depicted embodiment a pavement marking 2819a is clearly visible in assigned parking spot 2809a in a perspective view simulating the viewpoint of a driver approaching the assigned spot 2809a.

In the depicted embodiment a vehicle registration number 2819b is clearly visible on the license plate of car 2805a in flanking spot 2803a in a perspective view simulating the viewpoint of a driver approaching assigned spot 2809a. According to various exemplary embodiments of the invention interface 2802 is provided to a user on a screen of a user client device or in printed form (e.g. at a kiosk 2900 as described hereinbelow). Although interface 2802 is presented her as a still image, in some exemplary embodiments of the invention it is provided as a virtual reality animation so that the perspective changes as user client device 122 approaches assigned spot 2809a.

In some exemplary embodiments of the invention, use of graphical context information presentation contributes to ease of user assimilation of presented information.

Exemplary Public Kiosks

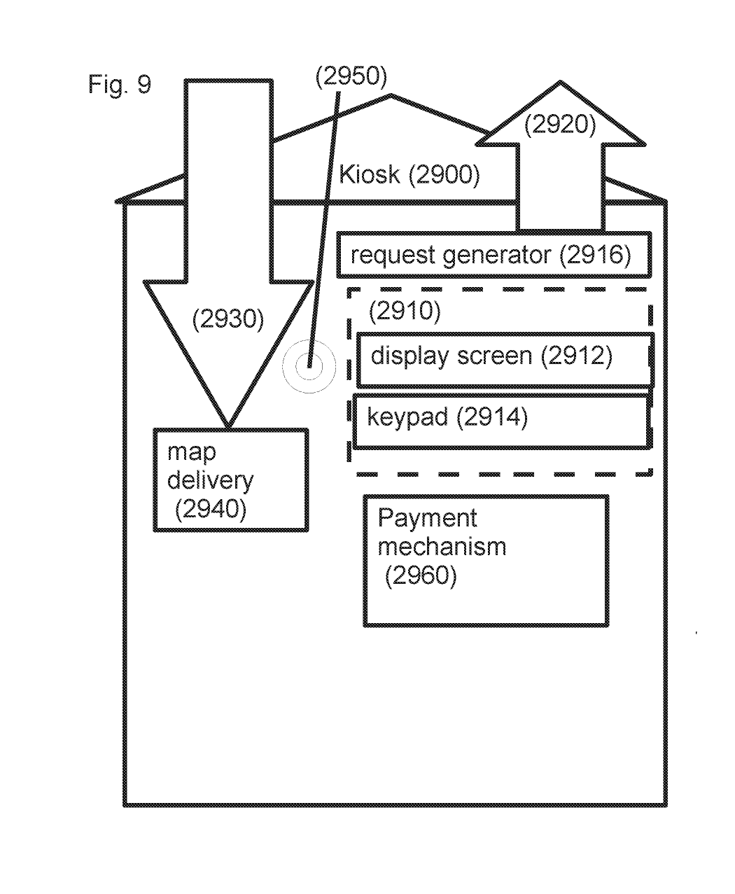

FIG. 9 is a schematic representation of a parking kiosk, indicated generally as 2900, for use in a computerized parking management system as described hereinabove according to some embodiments of the invention. In some embodiments deployment of kiosks 2900 in public places provides a system interface for users that do not have a user client device with them when they want to reserve a parking spot and/or park in an assigned spot and/or vacate an assigned spot. In some embodiments a request for a parking spot from kiosk 2900 automatically defines a location as “in proximity to this kiosk” and/or a desired parking time as “now+estimated driving time to the spot”.

Users that do not have a user client device with them include, but are not limited to, users that reserve a spot using a non-portable user client device (for example conventional telephone or desktop computer) and users that are roaming outside a service area of their personal user client device.

Depicted exemplary kiosk 2900 includes a user interface component 2910 accepting a vehicle registration number as an input. In the depicted embodiment component 2910 is depicted as including a display screen 2912 and keypad 2914. In some embodiments display screen 2912 is a touch screen and no keypad is provided. Alternatively or additionally, according to various exemplary embodiments of the invention keypad 2914 is a 10 key numeric keypad or a more robust alphanumeric input device (for example QWERTY keyboard). Alternatively or additionally, in some embodiments keypad 2914 includes “dedicated function” buttons such as new reservation, receive map for existing reservation, confirm parking, and exit notification. In other exemplary embodiments of the invention, “dedicated function” instructions appear on display screen 2912. For example:

Press 1 for new reservation;

Press 2 to receive map for existing reservation;

Press 3 to confirm parking and

Press 4 for exit notification.

In some embodiments user interface component 2910 of kiosk 2900 accepts confirmation of parking and/or exit as described above or in other ways.

In other exemplary embodiments of the invention, at least some functions of interface 2910 are voice based. According to those embodiments, interface 2910 includes a microphone and speaker (not depicted). For example, a microphone and speaker are provided as an intercom box or as a telephone receiver. According to various voice based embodiments a kiosk user is presented with an IVR menu via the speaker and makes selections via keypad 2914 and/or by using voice commands delivered into the microphone.

Depicted exemplary kiosk 2900 includes a request generator 2916 in communication with interface 2910. Request generator 2916 transmits the vehicle registration number as a reservation request 2920 to a parking reservation management server (for example 120 in FIG. 1) which assigns a specific parking spot to the vehicle registration number and generates a digital file encoding a map including navigation cues from the kiosk to the assigned spot. The server transmits the digital file 2930 to the kiosk. According to various exemplary embodiments of the invention data transmission is via any available network type.

Depicted exemplary kiosk 2900 also includes a map delivery apparatus 2940. According to some exemplary embodiments of the invention map delivery apparatus 2940 includes a printer that prints out the map encoded by digital file 2930.

Alternatively or additionally, in some embodiments there is provided a graphical or virtual reality representation of a car currently parked in at least one flanking spot as illustrated in FIG. 8C.

Alternatively or additionally, in some embodiments map delivery apparatus 2940 includes a data port for transmission of the map (encoded by digital file 2930) to an external device. Examples of data ports include, but are not limited to USB port, Bluetooth, infrared, microwave and NFC. Corresponding external devices include, but are not limited to USB drives, devices with USB ports (for example computer, tablet or smartphone), Bluetooth enabled devices (for example computer, car computer, tablet or smartphone) infrared enabled devices (for example computer, car computer, tablet or smartphone) and NFC enabled devices (for example tablet or smartphone).

In the depicted embodiment kiosk 2900 includes a camera 2950 positioned to capture an image of a user of user interface component 2910. According to various exemplary embodiments of the invention the camera is a still camera and/or a video camera.

In the depicted embodiment kiosk 2900 includes a payment mechanism 2960. According to various exemplary embodiments of the invention payment mechanism 2960 includes credit card transaction processing capability and/or coin handling capability and/or banknote handling capability. According to various exemplary embodiments of the invention payment is made in advance or at parking checkout.

According to various exemplary embodiments of the invention the kiosk is stationary or portable (for example for use at special events). Alternatively or additionally, according to various exemplary embodiments of the invention the kiosk sends request 1920 and/or receives digital file 2930 via a wireless and/or a wired network. In some embodiments kiosks 2900 with wired network connections continue to function when user client devices relying on wireless connections (for example cell phones) are not in services due to failure of a network (for example a cellular communications network) which is used by system 100 but is not part of system 100.

Exemplary Special Feature Spot Assignment Method

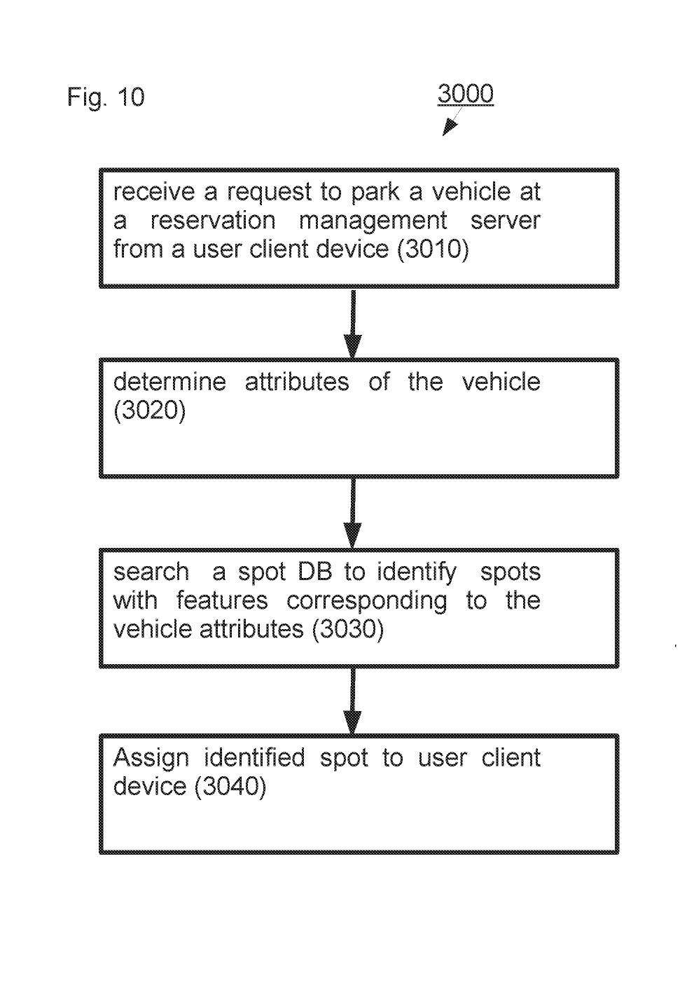

FIG. 10 is a simplified flow diagram of a computerized parking management method, indicated generally as 3000, according to some exemplary embodiments of the invention.

Depicted exemplary method 3000 includes receiving 3010 a request to reserve a parking spot for a vehicle at a reservation management server from a user client device and determining 3020 (for example across a network or via a query to an internal DB) attributes of the vehicle and searching 3030 a spot DB to identify spots with features corresponding to the vehicle attributes. Spot features include fixed physical characteristics (for example a charger for an electric cars and indoor/outdoor status, handicap vehicle clearance (for example rear or side clearance for a lift) as well as flexible administrative permissions (for example Handicap permit and resident permit).

In some embodiments the request includes a vehicle identification number and said determining 3020 includes retrieval of data from a vehicle DB. Alternatively or additionally, in some embodiments the request includes a user name and/or password and the determining includes retrieval of a user profile including attributes of the vehicle. Alternatively or additionally, in some embodiments vehicle attributes include physical characteristics (for example electric powered; propane powered, handicap lift, freight lift).

Alternatively or additionally, in some embodiments vehicle attributes include status characteristics (for example handicap and/or resident and/or emergency and/or law enforcement and/or delivery and/or municipal service vehicle and/or utility vehicle (for example telephone company or electric company)).

In some embodiments the request includes a destination.

In some embodiments method 3000 includes assigning 3040 a spot identified at 3030 to vehicle. Alternatively or additionally, in some embodiments location coordinates in machine readable format are provided to the user client device that made the request for use on that user client device or a different user client device. Alternatively or additionally, in some embodiments location coordinates in machine readable format are provided to a different user client device than the one that made the request (e.g. a kiosk 2900). In some embodiments, the location coordinates in machine readable format are used by a device incapable of communication with system 100. For example, a map printed at kiosk 2900 includes a QR code. The user requested a printed map from the kiosk because they are roaming in an area where they have no data coverage. A smartphone belonging to the user uses a camera incorporated therein to scan the QR code. Scanning launches a map application stored locally on the smartphone and indicates the position of the assigned spot.

Exemplary Smart Spot Selection Method

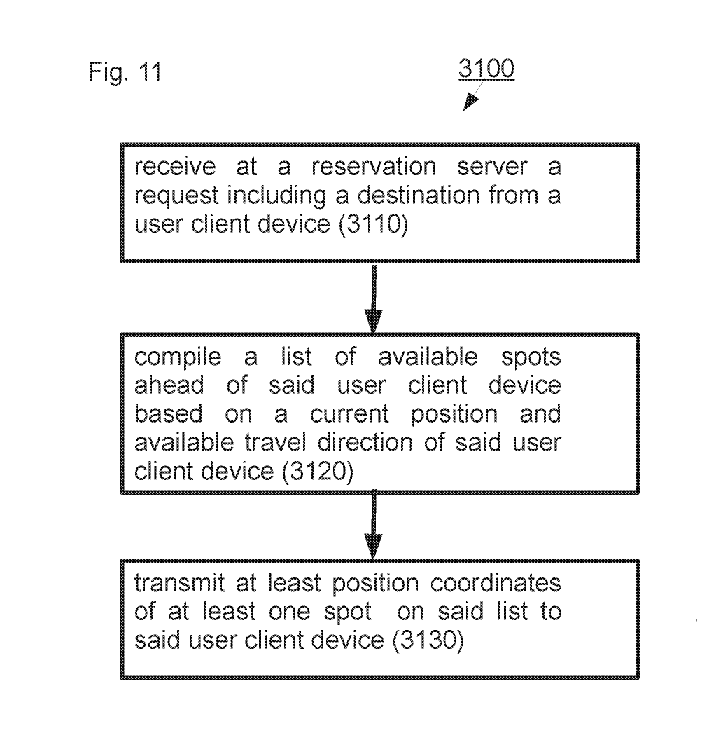

FIG. 11 is a simplified flow diagram of a computerized parking management method, indicated generally as 3100 according to some exemplary embodiments of the invention. These embodiments accommodate scenarios in which, for example, a spot becomes available after a user has passed it on a one-way road. Although the spot may be the closest available spot, its position behind the user makes it difficult to reach. Other spots located farther away but ahead of the user are easier and/or faster to reach. These embodiments contribute to an ability of the user to arrive at an assigned spot without violation traffic regulations and/or in less time than it would take to return to the spot they had already passed via a legal route.

Depicted exemplary method 3100 includes receiving 3110 at a reservation management server a request to park including a destination from a user client device and compiling 3120 a list of available spots ahead of the user client device based on a current position and available travel direction of the user client device and transmitting 3130 at least position coordinates of least one spot on the list to the user client device.

Available travel direction is a flexible parameter that considers distance and/or time of the shortest route to a spot which can be legally travelled to a specific available spot from a current location. In some embodiments as the percentage of occupied spots in an area increases, the available travel direction parameter is relaxed so that spots which are further away on the shortest legal route and/or require more time to reach on the shortest legal route are eligible for inclusion in the compiled list.

Exemplary Destination Suggestion Method

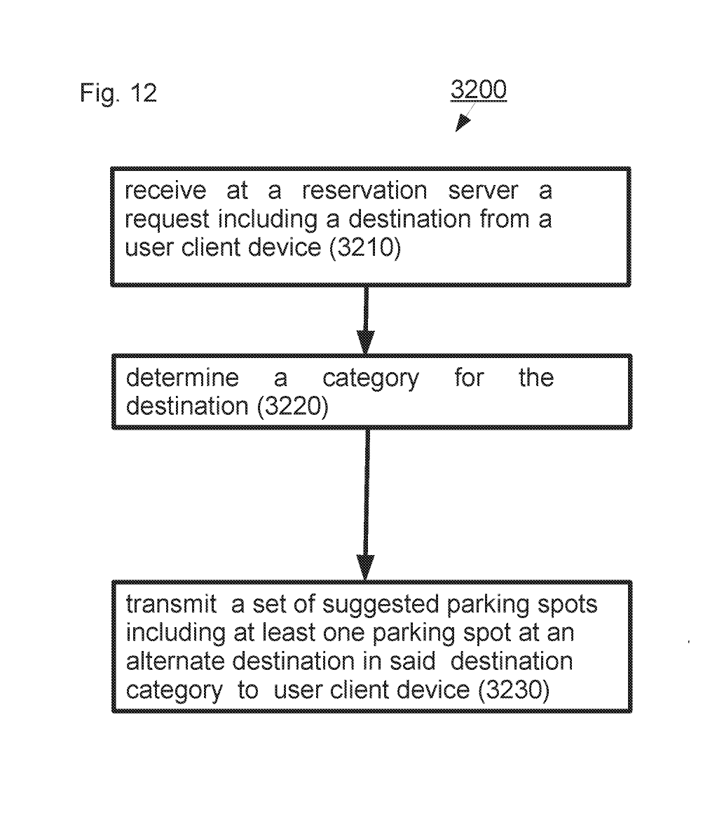

FIG. 12 is a simplified flow diagram of a computerized parking management method, indicated generally as 3200 according to some exemplary embodiments of the invention. Depicted exemplary method 3200 includes receiving 3210 at a reservation management server a request to park including a destination from a user client device, determining 3220 a category for the destination and transmitting 3230 to the user client device a set of suggested parking spots including at least one parking spot at an alternate destination in the destination category. In some embodiments determining 3220 includes a keyword analysis of the destination. For example, mall, beach, park and cinema are examples of keywords. Retail chain names also serve as keywords in some embodiments. In some embodiments alternate destinations within a category are included in a list of suggested parking spots when the destination indicated in the request has little or no parking available and/or when parking at the destination indicated in the request would require a significant wait. In some embodiments inclusion of alternate destinations within a category in a list of suggested parking spots warns an operator of the user client device that the originally selected destination is crowded.

Alternatively or additionally, in some embodiments the destination (received at 3210) includes a street address and determining 3220 includes a query to a directory to determine what is at the address.

Alternatively or additionally, in some embodiments a parking spot in the set of suggested parking spots is characterized in terms of estimated wait time for availability. In some embodiments information pertaining to distance from destination and/or hourly parking rate are also provided. In some embodiments, such as a mall parking lot, system 100 sets maximum permitted parking time well above the time the average shopper takes based on analysis of historic data in event DB 168. In some embodiments this contributes to an increase in estimated wait times. Alternatively or additionally, longer reservations are filled with spots further from the entrance.

Exemplary Public Transportation Suggestion Method

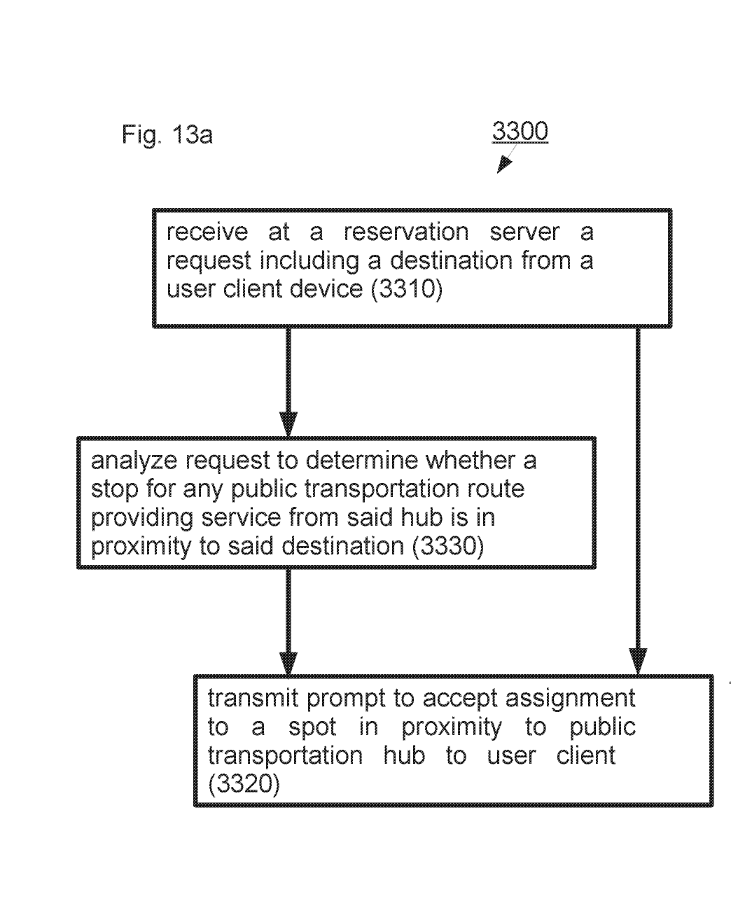

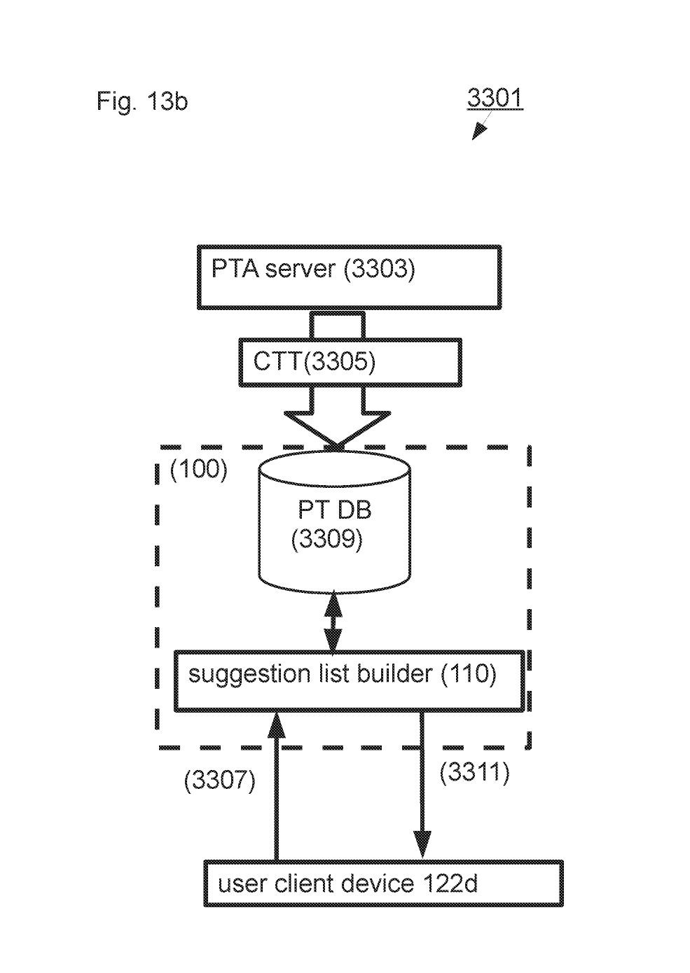

FIG. 13a is a simplified flow diagram of a computerized parking management method, indicated generally as 3300 according to some exemplary embodiments of the invention.

Depicted exemplary method 3300 includes receiving 3310 a parking request including a destination at a reservation management server and transmitting 3320 a prompt to accept assignment to a spot in proximity to public transportation hub in response to the request. In some embodiments the prompt is received at a user client device from which the request originated.

In some embodiments method 3300 includes analyzing 3330 the request to determine whether a stop for any public transportation route proving service from the hub is in proximity to the destination. According to various exemplary embodiments of the invention proximity is defined in terms of distance (for example 100, 200, 300, 400 or 500 meters or intermediate or lesser distances.) and/or in terms of estimated walking time (for example 1 minute, 2 minutes, 5 minutes, or 10 minutes or intermediate or greater times).

Alternatively or additionally, in some embodiments method 3300 includes including in the prompt information on how much closer to the destination the stop (in closest proximity to the destination) is than the available parking spot closest to the destination. Alternatively or additionally, in some embodiments method 3300 includes including in the prompt information on how much money is potentially saved by using public transportation from the hub. In some embodiments parking at hub and public transportation shuttle are both free, so savings equals the hourly rate times the number of parking hours.

Alternatively or additionally, in some embodiments method 3300 includes including in the prompt information on how much time is potentially saved by using public transportation from the hub.

FIG. 13b is a schematic representation of information flow, indicated generally as 3301, according to some exemplary embodiments of the invention. In some embodiments information flow 3301 contributes to an ability of system 100 to provide prompt information on how much time is potentially saved by using public transportation from the hub.

In depicted embodiment 3301 a server 3303 operated by a Public Transportation Authority (PTA) periodically updates a public transportation DB 3309 with Current Travel Time (CTT) data 3305. CTT data 3305 includes information pertaining to public transportation hubs with parking spots and transportation lines operating from those stops, and the stops on each line. Each hub and each stop is defined in terms of location coordinates. In some embodiments CTT data 33305 indicates a current travel time from each hub to every stop serviced by that hub and a relevant line which services each stop.

According to various exemplary embodiments of the invention the updates occur every 30, 10, 5, 3, 2 or 1 minutes or with intermediate or shorter intervals.

In the depicted embodiment PT DB 3309 is part of system 100 (FIG. 1). Suggestion list builder 110 of system 100 receives parking requests 3307 from user client devices 122d equipped with navigation devices that sense current position and provide an estimated time of arrival at a current destination. According to the depicted embodiment, each parking request 3307 indicates a current location, a current destination and the current ETA. List builder 110 compares the information in each request 3307 to information PT DB 3309 using a predefined logic flow.

One example of a predefined logic flow is:

1) Determine if there is a public transportation stop in proximity to the current destination in request 3307. (definition of proximity is a variable which is defined by system 100 and/or a user profile associated with user client device 122d and/or a vehicle registration number in request 3307). If Yes, a prompt 3311 inviting user client device to use public transportation is to be prepared. If No, request 3307 is handled according to one or more of the other methods and/or systems described herein.

2) Estimate an ETA (d) for the operator of user client device 122D if they use public transportation by calculating:

(d)=[(a)+(b)+(c)]+[current time] where:
(a) is an estimate of travel time for user client device 122D from its current location to a transportation hub;
(b) is current data from PT DB 3309 on travel time from the hub to the identified public transportation stop in proximity to the current destination in request 3307;
(c) is the estimated walking time from identified public transportation stop in proximity to the current destination in request 3307 and the current destination in request 3307.

3) Estimate a potential time savings from using public transportation by calculating:

Potential time savings=(d)−(current ETA in request 3307)

In the depicted embodiment, upon completion of this comparison, suggestion list builder 110 provides a prompt 3311 to user client device 122D asking the if the current destination should be changed to a transportation hub and providing an estimate of how much time will be saved by travelling to the hub and using public transportation to travel from the hub to a stop in proximity to the destination. If the user of user client device confirms prompt

In some embodiments method 3300 is only applied to requests from users that have opted in. In other exemplary embodiments of the invention, the method actively recruits public transportation users.

Exemplary Analysis of Parking History

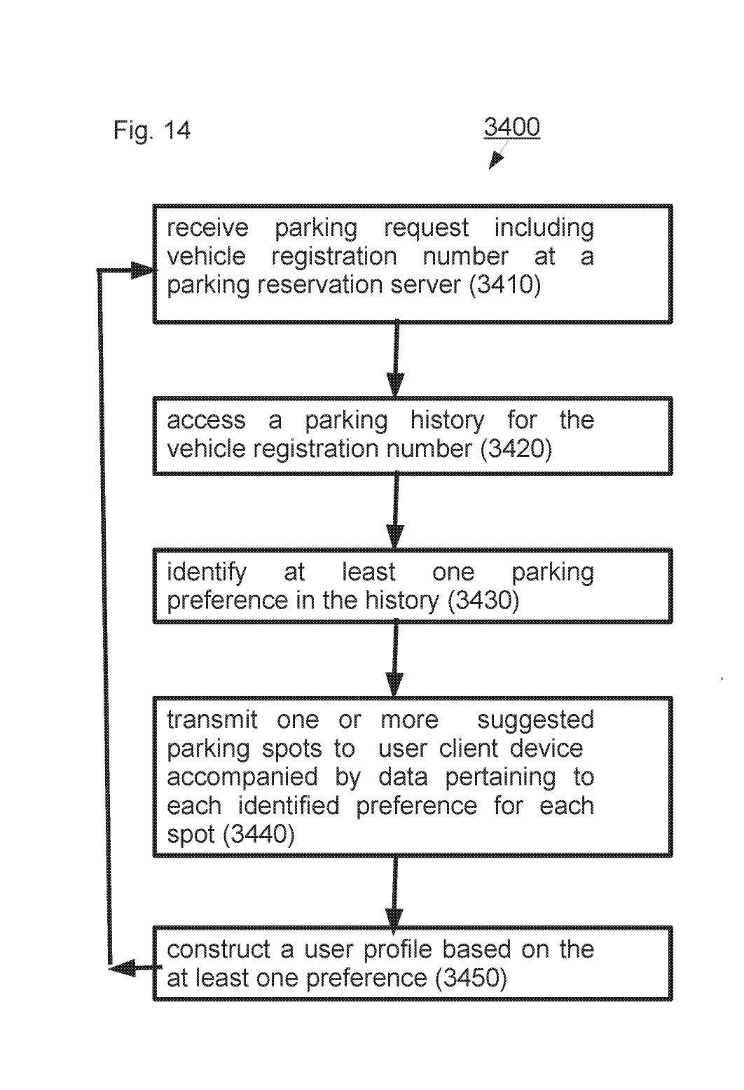

FIG. 14 is a simplified flow diagram of a computerized parking management method, indicated generally as 3400 according to some exemplary embodiments of the invention.

Depicted exemplary method 3400 includes receiving 3410 a parking request including a vehicle registration number at a parking reservation server. In some embodiments the request includes a destination.

In some embodiments method 3440 includes accessing 3420 parking history for the vehicle registration number (for example from DB 168; FIG. 1). In some embodiments the history includes duration of previous parking events for the destination. Alternatively or additionally, in some embodiments the history includes destinations defined for previous parking events.

In some embodiments method 3440 includes identifying 3430 at least one parking preference in said history. In some embodiments identifying 3430 includes pattern analysis. For example, if a user routinely drives to a specific destination on Tuesday evenings, the system prompts the user by sending a query (for example pop up window and or voice prompt) “Are you looking for a spot near the corner of Main St. and fourth Ave.? In some embodiments identification of a user preference from a history contributes to an obviation of a need for destination data entry. Alternatively or additionally, in some embodiments a user provides recurring events including locations and schedule information as part of a user profile.

In some embodiments method 3400 includes transmitting 3440 one or more suggested parking spots to said user client device, accompanied by data pertaining to each identified preference for each spot. In some embodiments transmitting 3440 is of a single parking spot reserved for the vehicle registration number. In other exemplary embodiments of the invention, a list of available spots is transmitted.

In some embodiments method 3400 includes constructing 3450 a user profile based on said at least one preference. According to these embodiments the construct profile is used to identify parking preferences in the future (arrow from 3450 to 3410).

Exemplary Driver Based Enforcement Method

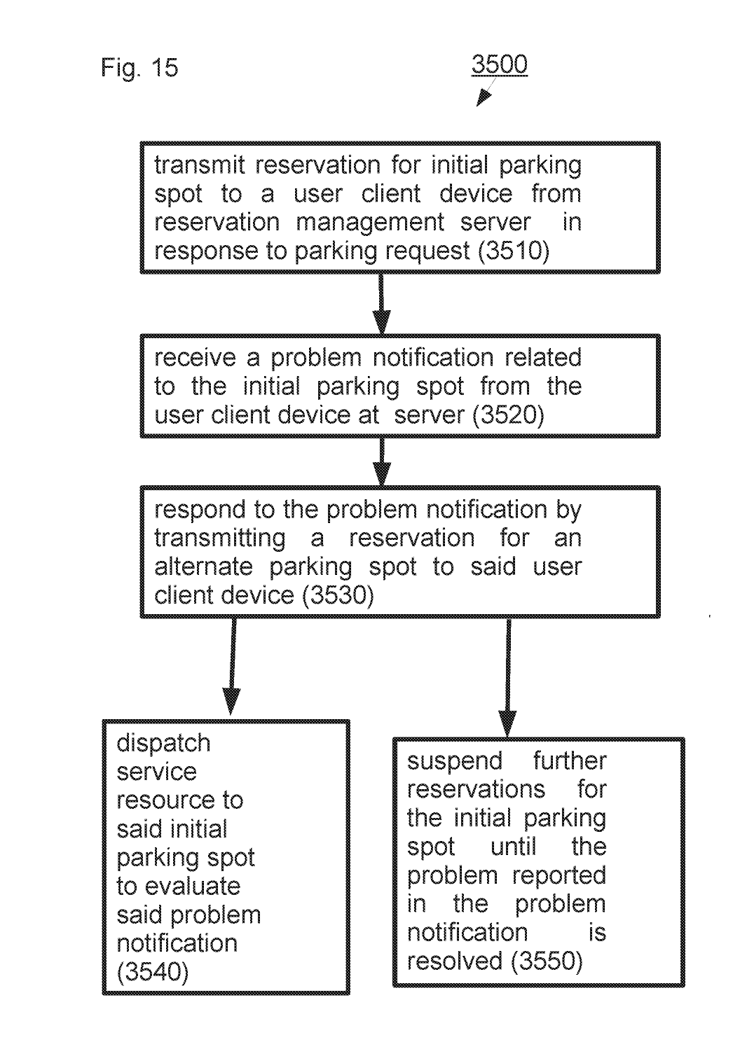

FIG. 15 is a simplified flow diagram of a computerized parking management method, indicated generally as 3500, according to some exemplary embodiments of the invention.

Depicted exemplary method 3500 includes transmitting 3510 a reservation for an initial parking spot to a user client device from a reservation management server in response to a parking request; receiving 3520 a problem notification related to the first parking spot from the user client device at the server; and responding 3530 to the problem notification by transmitting a reservation for an alternate parking spot to the user client device. In one embodiment, the problem notification is transmitted by touching or pushing an appropriate button (not shown) on the user client device.

In some embodiments the reservation for an alternate parking is processed by the system with a higher or preferred priority in accordance with preset criteria. Preferred priority indicates processing first, ahead of reservations previously received and/or changing an existing reservation for a different vehicle on order to provide the alternate parking spot.

In some embodiments exemplary method 3500 includes dispatching 3540 a service resource to said initial parking spot to evaluate said problem notification. Alternatively or additionally, in some embodiments exemplary method 3500 includes suspending 3550 further reservations for said first parking spot until a problem of the problem notification is resolved. In some embodiments suspending 3550 is accompanied by changing the status of the initial spot in spot DB 164, According to various exemplary embodiments of the invention the status is change to occupied and/or violation (indicates a need for violation report and/or towing) or unavailable (for example if access to the spot is blocked, but not by a vehicle).

In some embodiments, in case of a violation a notification is sent directly to the user client device 122 of the relevant driver from violation system 130. In some embodiments the notification is in the form of a text message and/or a voice message and/or a push notification through a smart phone application and/or a phone call.

For example, a problem notification indicates an unauthorized car parked in the initial parking spot. Resolution of the problem is towing of the car (for example by a dispatched 3540 service vehicle in the form of a tow truck), which makes the initial spot available again. According to various exemplary embodiments of the invention between receipt of the problem notification towing the car the status of the spot in spot DB either remains “reserved” or is switched to “occupied” or is switched to “violation”.

As another example, a problem notification indicates a spot is covered by a large pile of snow resulting from clearing of a parking lot by snowplows. Resolution of the problem may occur only when the snow melts, which makes the spot available again. In this scenario repeated periodic (for example daily) dispatch 3540 of a service vehicle to monitor the situation is indicated.

In some embodiments dispatch 3540 is of an automatic (driverless) service vehicle via transmission of a service request as one or more packets of digital data from the server (for example 120 in FIG. 1) to the vehicle across an available network.

Exemplary Multi-User Client Device Method

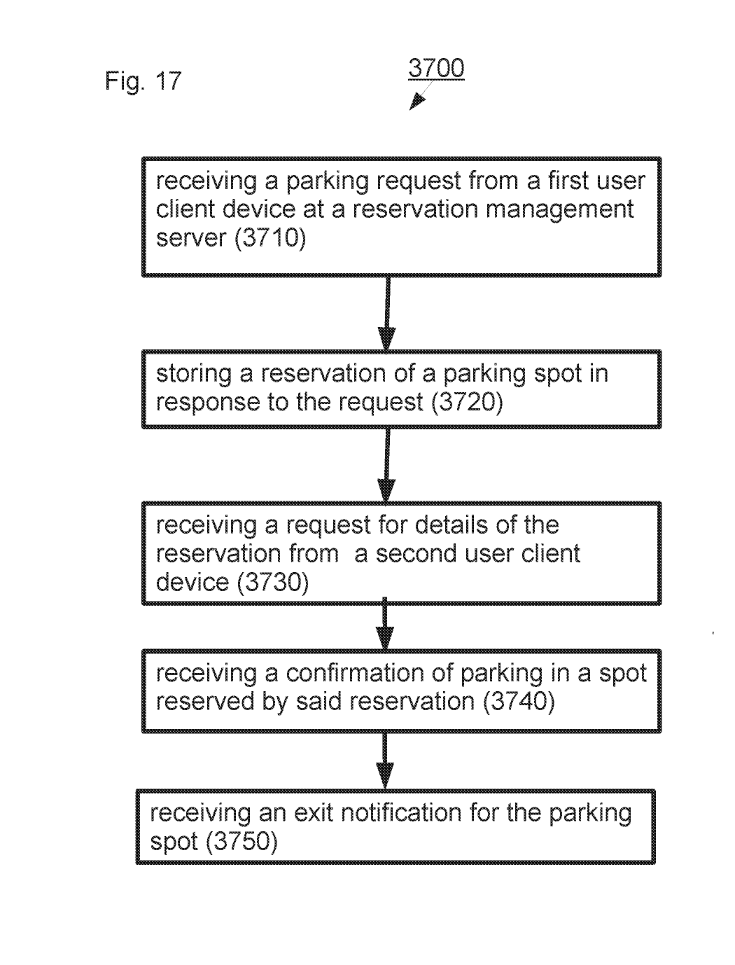

FIG. 17 is a simplified flow diagram of a computerized parking management method, indicated generally as 3700, according to some exemplary embodiments of the invention.

Depicted exemplary method 3700 includes receiving 3710 a parking request from a first user client device at a reservation management server (for example 120 in FIG. 1) and storing 3720 a reservation of a parking spot in response to the request. In some embodiments the request includes a destination and/or a vehicle registration number and/or a reference to a user profile. According to various exemplary embodiments of the invention the first user client device is a device of any type. In some exemplary embodiments of the invention, the first user client device is non-portable (for example a conventional PSTN telephone or a home computer operating a web browser) and/or has limited graphics capabilities (for example a 2G phone).

According to these embodiments, the server then receives 3730 a request for details of the reservation from a second user client device. The request for details includes sufficient information for identification of the request (for example vehicle registration number and/or a reference to a user profile). Reference to a user profile may be, for example, a username and/or password.

For example, in one embodiment, a user makes a parking request from a non-portable first user client device in their home and subsequently makes a request for details from a public kiosk (for example 2900; FIG. 9) filling the role of second user client device.

As another example, in one embodiment, a user makes a parking request from a non-portable first user client device in their home and subsequently picks up a neighbor carrying a smartphone and travelling to a shared destination. In this scenario, the neighbor's smartphone serves the role of second user client device. This scenario offers navigation instructions en-route.

In some embodiments method 3700 includes receiving 3740 a confirmation of parking in a spot reserved by said reservation. According to various exemplary embodiments of the invention confirmation originates from any user client device capable of communication with the system so long as the confirmation includes sufficient information for identification of the relevant reservation (e.g. vehicle registration number and/or a reference to a user profile and/or a UID of a parking spot and/or identifying information pertaining to the first user client device (for example a home phone number)).

In some embodiments method 3700 includes receiving 3750 an exit notification for the parking spot. Again, according to various exemplary embodiments of the invention confirmation originates from any user client device capable of communication with the system so long as the confirmation includes sufficient information for identification of the relevant reservation (for example vehicle registration number and/or a reference to a user profile and/or a UID of a parking spot and/or identifying information pertaining to the first user client device (for example a home phone number).

Exemplary Integrated Used Experience

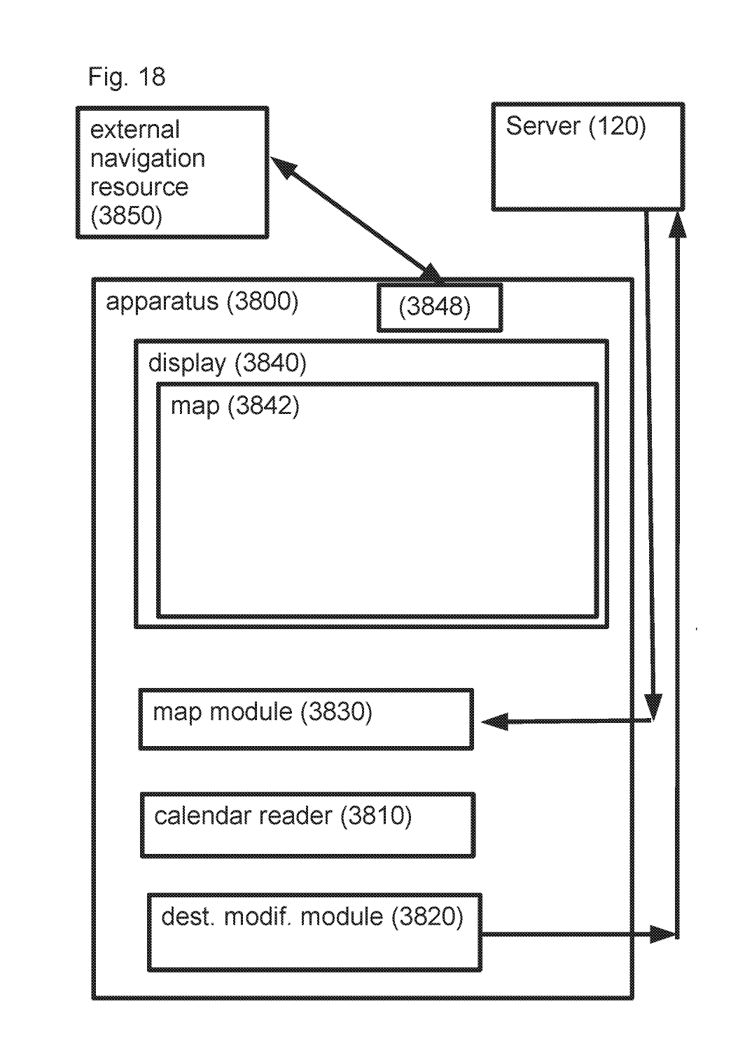

FIG. 18 is a schematic representation of a user client device, indicated generally as apparatus 3800. In some embodiments the user client device integrates calendar, parking reservation and navigation functions in a seamless user experience.

In the depicted embodiment user client device 3800 includes a display screen 3840. In some exemplary embodiments of the invention, screen 3840 is a touchscreen.

In some exemplary embodiments of the invention, user client device 3800 includes a calendar reader 3810 that reviews entries in a digital calendar and prompts the user for confirmation that one or more future events presented in a list is a current destination. According to various exemplary embodiments of the invention the calendar is maintained locally on user client device 3800 and/or synchronized with a calendar maintained on a different user client device. According to various exemplary embodiments of the invention list presentation by calendar reader 3810 is via display 3840 (for example using a format similar to that of FIG. 2a with calendar entries replacing parking spots). Alternatively or additionally, in some embodiments list presentation by calendar reader 3810 includes audio presentation via one or more speakers included in, or available to, user client device 3800 (speakers not depicted). According to various exemplary embodiments of the invention selection of a list item from the presented list is via voice command (using a microphone, not depicted) or via touching an item in a list displayed on display 3840.

In some embodiments of the invention, user client device 3800 includes a destination modification module 3820 that prompts the user for a parking reservation request in response to selection of an item from the list. Upon confirmation of the prompt, destination modification module 3820 issues the parking reservation request to a reservation management server 120 via a network. In some embodiments, confirmation is active (by voice command or via touching display 3840) and in other embodiments confirmation is passive. According to various exemplary embodiments of the invention passive confirmation occurs when there is no user response to a prompt after 5, 10, 15, 30 or 60 seconds or intermediate or longer amounts of time. Alternatively or additionally, in some embodiments destination modification module 3820 prompts the user to request parking at the beginning of a journey or as the vehicle approaches the selected destination. This is achieved, for example, as explained in the context of FIG. 5 and system 2500 hereinabove.

In some embodiments user client device includes a mapping module 3830 displaying current position on a map 3842 based upon output from a tracking device 3848 in communication with an external navigation resource 3850. In some embodiments external navigation resource 3850 includes a GNSS system (Global Navigation Satellite System). Examples of GNSS include, but are not limited to, American (GPS), Russian (GLONASS), European (GALILEO) and Chinese (BeiDou-2) systems. Alternatively or additionally, in some embodiments the external navigation resource 3850 includes at least one network communication station, for example one or more cellular communication towers and triangulation.

In some embodiments a calendar entry selected as a current destination includes location information (as opposed to coordinates) and calendar reader 3810 transmits the location information from the current destination to destination modification module 3820 for inclusion in in the parking reservation request.

In other exemplary embodiments of the invention, a calendar entry selected as a current destination does not include location information. In the absence of location information for a selected destination, destination modification module 3820 provides a prompt for location information for inclusion in the parking reservation request.

Upon receipt of the parking reservation request, the server locates one or more specific parking spots defined by location coordinates and transmits coordinates for one or more specific spots back to user client device 3800 for use by map module 3830.

In some embodiments coordinates for a single spot are transmitted and map module 3830 begins navigation to the specific parking spot using map 3842 on display 3840 and/or audio cues.

In other exemplary embodiments of the invention, coordinates for two or more spots are transmitted and map module 3830 provides a list for user selection. List display in this case is similar to FIG. 2a. Upon user selection of a spot from the list (actively or passively as described above) map module 3830 begins navigation to the selected specific parking spot using map 3842 on display 3840 and/or audio cues.

Integration of the user experience contributes to an increase in safety and/or a decrease in user distraction while driving a vehicle.

Additional Exemplary System

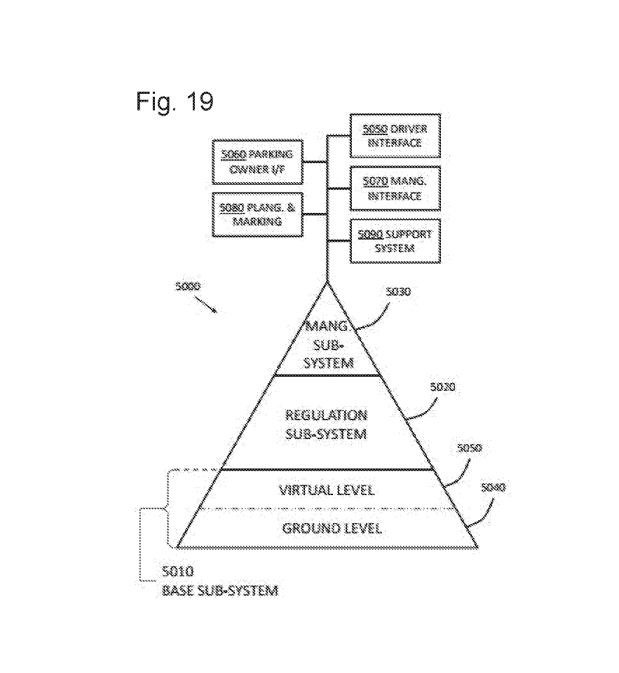

FIG. 19 is a schematic representation of a parking system, indicated generally as 5000, according to some embodiments of the invention. System 5000 is similar to system 100 (FIG. 1) in many respects.

Depicted exemplary system 5000 includes a base sub-system 5010, a regulation sub-system 5020, a management sub-system 5030, and multiple interfaces. The three sub-systems 5010, 5020, and 5030 interact as layers to effectively serve a large and diversified population of drivers seeking convenient parking.

The first layer, the base sub-system 5010, has a ground level 5040 and a virtual level 5050. The ground level 5040 references the management of the physical marking of all the parking spaces in the system 5000. Non-limiting examples of the physical marking are painting parking spot numbers on or adjacent the pavement of the spot and posting signs adjacent the spot to display the spot numbers. The virtual level 5050 of the base sub-system 5010 maintains digital representations of the parking spaces spots and their supporting infrastructures. In some implementations, the virtual level 5050 has, for each stored parking spot, location coordinates (see spot DB 164 in FIG. 1) and relevant dimensions.

The second layer, the regulation sub-system 5020, stores for each parking spot digitally represented in the base sub-system 5010 rules that govern when and how the spot is used. Rules dictate whether the spot is available to the general public or reserved for handicapped use and/or which times of day, if any, the spot is unavailable and/or how much it costs for the user to park there, as non-limiting examples.

The third layer, the management sub-system 5030 (compare to server 120 in FIG. 1), allocates parking spots registered in the base sub-system 5010 according to the rules in the regulation sub-system 5020. Duties of the regulation sub-system 5020 include recording for retrieval the occupancy status for each spot and the enforcement of the parking rules, which will be discussed in more detail below.

The system 5000 includes a driver interface 5050 that enables registrants to reserve spaces, to later notify the system 5000 that the spaces have been vacated, and additional communications discussed in more detail below. Human users interface with system 5000 via user client devices, for example via a smartphone (application) and/or a 2G phone (voice/SMS) and/or a public kiosk (for example 900) and/or a website and/or an onboard vehicle computer for either a human-driven or an automatic vehicle,

Depicted exemplary system 5000 includes a parking owner interface 5060, which enables owners of parking facilities, such as a city municipality with respect to public parking, a private parking lot or garage owner, or a private individual, to set rules for the use of their parking spaces. Example rules are a city restricting parking in some space during peak traffic times and a home owner offering his/her space for use during specified times only.

Another interface of the system 5000 is management interface 5070. Such interface enables a command and control center (CCC 151; FIG. 1) to access the system 5000. In embodiments implementing human ushers to assist users in reaching their spaces, the usher accesses the system 5000 via management interface 5070.

Some embodiments of system 5000 include a planning and marking module 5080 for use by engineers and/or field contractors. To implement the system 5000, the engineers and/or field contractors map city parking facilities and upload the parking map(s) through the planning and marking module 5080 to the virtual level 5050 of the base sub-system 5010.

Embodiments of the system 5000 further include a support system module 5090 for use by some or all of the following: a branch of the government's division of motor vehicles (DMV)/motor vehicle administration (MVA), a downfall system, a closed space system, a blind spot system, a payment system, a data logging, analytics, and a backup system.

The downfall system is an alternate parking administration system to be implemented if the primary functionalities of system 5000 fail. One non-limiting example of a downfall system includes the parking space markings, signs, and regulations that were in place before system 5000 was implemented.

A closed space system manages vehicle tracking and space identification in locations where GPS reception is unreliable or non-existent, an example of the latter is within a parking garage. Other forms of tracking implement Wi-Fi, ultrasound, and infrared technologies. The related system for blind spots provides tracking during temporary GPS lapses, such as during inclement weather.

In some embodiments payment systems are also implemented to manage financial transactions between users and parking spot owners, and the payment system provides data to the system 5000 through the support system module 5090.

Data logging stores every parking event (see event history DB 168; FIG. 1), such as when a user reserves a space, occupies a space, and later vacates a space. The data that are logged become available for analytics. The analytics provide real-time and/or historic and/or predicted statuses of parking spot use. Also, the data become available for determining trends to facilitate better parking allocation in the future. For example, in some embodiments system 5000 observes congestion in some areas on weekends and responds by directing some users to park in less congested areas.

The backup system, which also interfaces with the rest of system 5000 through system module 5090, enables the system 5000 to continue functioning even if some of the components malfunction. For example, in some embodiments the backup system implements redundant data storage, servers, and/or communication paths to be used primarily if one or more of the storage, servers, and/or communication paths malfunction.

Exemplary User Client Devices

According to various exemplary embodiments of the invention a smartphone (e.g. using APPLE IOS or ANDROID OS), a tablet device, a wearable device (e.g. APPLE watch or ANDROID wear), a personal computer (e.g. laptop or desktop), an onboard computer in a vehicle, a 2G mobile phone, a conventional phone (operating through the public switched telephone network) and a kiosk serve as a user client device. According to various exemplary embodiments of the invention the onboard computer in a vehicle is selected from the group consisting of a portable device, a built in device in a standard (driver operated) car and a built in computer on an automatic (driverless car).

Different user client device types interface with the system in different ways.

For example, a smartphone or onboard computer interfaces with the system using software installed on the client device. Depending on the software design the system transmits information (for example, cues and/or options) to the client device for display on the screen of the client device and/or as audio output though a speaker of the client device. A user input responses to the device using a touchscreen and/or by voice activation. In some embodiments if no user input is received within a pre-set time period, the system proceeds according to a default selection (for example, the first item in a list).

Alternatively or additionally, in some embodiments a smartphone or 2G phone transmits an SMS to a designated telephone number which serves as a system interface. Successive exchanges of information are conducted via SMS according to these embodiments.

Alternatively or additionally, in some embodiments a tablet device or a personal computer (for example, laptop or desktop) serves as a user client device. According to these embodiments exchanges between the user client and the system of information are, for example, via an internet portal operated by the system.

Alternatively or additionally, in some embodiments a smartphone or 2G phone or a conventional telephone places a telephone call to a designated telephone number which serves as a system interface. According to these embodiments exchanges of information are via an IVR (integrated voice response) system and/or a call center.

In some embodiments a dedicated kiosk serves as a user client device for users of the system that do not have another device available to them and/or to supplement another user client device employed to complete a portion of the reservation process. for example, a user that used their home telephone to reserve a parking spot via an IVR interface uses a kiosk in proximity to their assigned spot to notify the system when they arrive and depart from their assigned parking spot.

In some embodiments a parking attendant operates a user client device for users that do not have a device of their own.

Alternatively or additionally, in some embodiments the system identifies a vehicle based upon a user client device. For example, in some embodiments a phone number is associated with vehicle registration number in a user profile (e.g. stored in vehicle DB 162). In those embodiments where a smartphone serves as a user client device, the phone number of the user client is available even if an incoming reservation request is via data network, as opposed to in the form of a telephone call.

Exemplary Driver IDs

According to various exemplary embodiments of the invention system 100 identifies drivers in addition to or instead of vehicles. In some embodiments a driver is associated with a driver UID and/or a reputation of the driver. Examples of driver UIDs include, but are not limited to IMEI (international mobile station equipment identity code) of the driver's cellphone, an ANDROID_ID for ANDROID devices, or a MAC Address for a MACINTOSH device. In some exemplary embodiments of the invention, one or more driver Ids are associated with, or are part of, a user profile.

Vehicle Icons

In some embodiments, system 100 (FIG. 1) includes, or has access to, a database of vehicle icons. Icons are designed to convey information pertaining to general vehicle type and/or appearance (for example, car/truck/SUV) and/or specific vehicle type (for example, sedan/station wagon/coupe/hatchback) and/or manufacturer (for example, FORD, CHEVY, HONDA, MAZDA, TOYOTA) and/or model (for example, COROLLA, CAMRY) and/or model year (or sets of model years with distinctive design features) and/or other characterizing features, such as color or shape. According to various exemplary embodiments of the invention the icons are two dimensional or three dimensional. In some embodiments the icons are empty line drawings and are filled with an appropriate color prior to use. In other exemplary embodiments of the invention, each icon is stored as multiple copies in different colors. In some embodiments icons are stored in vehicle DB 162 as a portion of individual vehicle records or as a separate collection of information within the DB.

Generation of Location Mockups

In some embodiments, system 100 (FIG. 1) uses a UID and/or position coordinates of a specific parking spot to generate a visual representation of the spatial context of the parking spot. The visual representation, in digital format, is transmitted to a user client device 122. In some embodiments user client device 122 is destined to the specific spot (for example, a smartphone or onboard computer). In some embodiments the transmission of the visual representation is made as the relevant user client device approaches the spot. In some embodiments a single fixed angle picture serves as the visual representation. In other exemplary embodiments of the invention, the visual representation is a virtual reality file which changes as the user client device moves relative to the assigned parking spot.

In some embodiments building faces from external sources (for example, GOOGLE MAP™ street view) are added to the visual representation.

Exemplary View Switching

In some embodiments the view on a user client device switches to perspective or street view as the device approaches the destination and/or an assigned parking spot. According to various exemplary embodiments of the invention the switch occurs when a proximity threshold is crossed. According to various exemplary embodiments of the invention the proximity threshold is defined in terms of distance and/or estimated arrival time. Alternatively or additionally, in some embodiments reduction of vehicle speed below a speed threshold triggers a switch to perspective view/street view. In some embodiments this view switching indicates presentation of one or more additional views (for example, using a split screen or pop-up window). In some embodiments a single fixed angle picture is presented as the “switched view” (for example, in a pop-up window).

Exemplary Rule Attributes

According to various exemplary embodiments of the invention access to parking spots through the reservation system is controlled by rules. Each rule includes one or more rule attributes. In some embodiments a single rule includes 2, 3, 4, or 5 or more attributer. Alternatively or additionally, in some embodiments multiple rules are applied to a given parking spot. Exemplary rule attributes include, but are not limited to spot ownership type, temporal limitations (for example, days and/or hours during which the rule applies); user type limitations (for example, residents only), duration limitations (for example, maximum stay of 0.5, 1, 2 or 3 hours), and legal status. In some embodiments rules include an hourly payment rate for the spot.

In some embodiments rules have start date and/or end date and/or times as attributes. According to these embodiments future reservations for spots are handled in accord with the rules which will be applicable on the relevant date/time and not in accord with the rules in effect at the time the reservation is received.

In some embodiments “minimum availability” for a category is a rule attribute. This attribute indicates that no matter how many vehicles in a category (e.g. handicap) are already present in a defined area (e.g. a parking lot or a city block), at least X additional spots must remain available for that category. According to some exemplary embodiments of the invention X is an integer between 1 and a hundred.

Exemplary Rule Application Schemes

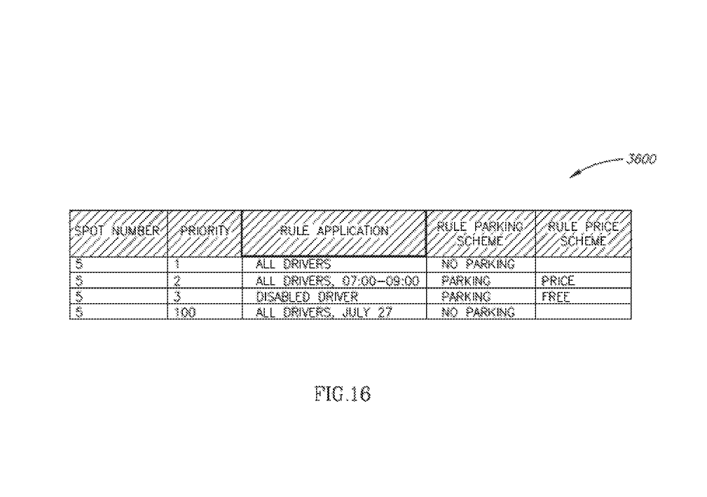

In some embodiments rules are applied in layers, with a highest layer number governing. FIG. 16 is a table, indicated generally as 3600 illustrating an exemplary rule application scheme according to some embodiments of the invention.

In the depicted embodiment a single spot number (5) is depicted in the leftmost column for clarity although the system is capable of applying rules, or changes to rule, to large numbers of spots concurrently.

In the depicted embodiment second column from the left indicates priority or layer. According to this embodiment the highest priority, or top layer, governs lower priorities or layers for spot(s) indicated in the leftmost column.

The middle column indicates rule attributes. Again the rules presented here are simplified for clarity although a single rule can be defined in a large number of attributes as explained in “Exemplary rule attributes: hereinabove”.

The second column from the right indicates parking scheme in terms of parking/no parking for vehicles and potential parking events matching all the attributes of the rule in the highest priority applicable layer.

The rightmost parking indicates price scheme in terms of free or fixed price for vehicles and potential parking events matching all the attributes of the rule in highest priority applicable layer.

Alternatively or additionally, in some embodiments the base layer excludes all vehicles at all times. According to these embodiments, each successive layer adds permissions. In some embodiments permissions are described in terms of rule attributes as detailed hereinabove and/or in terms of additional attributes and/or in terms of combinations of 2, 3, 4 or 5 or more attributes.

In some exemplary embodiments of the invention, table 3600 is a spreadsheet which receives data inputs and/or functions as a user interface.

Elevation Considerations

In order to facilitate navigation to a specific spot in a multistory garage, elevation coordinates are used in some embodiments. Alternatively or additionally, in some embodiments a UI displays level row and spot number on the display when the vehicle approaches the garage. Use of such a UI is advantageous in situations where tracking devices used in many smartphones do not function well, such as underground facilities.

Parking Lots/Garages

In terms of rulemaking considerations, some lots/garages may be permitted to rent out spots, or blocks of spots, independently of the system. For example, garages accustomed to leasing blocks of spots to companies in an adjacent office building are unlikely to surrender this revenue stream in order to participate in the system. In such cases the garage operator uses lot spot manager 153 to enter rules in rule and spot manager 150 indicating that the leased spots are either unavailable to any car at any time or are reserved for a specific vehicle identification number for the entire term of the lease. According to various exemplary embodiments of the invention rule making for spots within a parking lot or garage remains in the hands of owners (for example, for price determination) and/or be relegated to city control (for example, for traffic control purposes or load balancing). In some embodiments different levels of priority for spaces in a lot/garage are given to owner and city.

Exemplary Pavement Marking Considerations.

In some exemplary embodiments of the invention, pavement markings (for example 2819a in FIG. 8c) correspond to the UID assigned to a specific spot in spot DB 164. In other exemplary embodiments of the invention, shorter alphanumeric indicators, such as a 2 or a 3 digit numeral and/or a single letter or two letter combination serve as pavement markings.

According to these embodiments, a relevant pavement marking is associated with each UID in spot DB 164 together with the location coordinates of the spot.

Although the same pavement marking may be used many times within an area under administration of system 100 (FIG. 1) confusion is unlikely so long as sufficient location information (such as a printed map or navigation instructions) is provided to each user client device that reserves a parking spot. In some embodiments a “pavement marking” is applied to a sidewalk, curb, adjacent wall or sign instead of to a road surface.

Exemplary User Profile Considerations

According to various exemplary embodiments of the invention user profiles are stored within system 100 (for example as part of Vehicle DB 162) and/or on user client devices 122.

Alternatively or additionally, according to various exemplary embodiments of the invention user profiles are compiled and maintained by a user and/or are assembled by system 100 (for example from event history DB 168).

For user profiles compiled and maintained by a user, a user interface is provide, for example via an application installed on a user client device or via an Internet portal. In some embodiments the user interface employs a username and/or password

In some embodiments a user interface for user profiles compiled and maintained by a user includes fields such as, for example “my vehicles” and/or “my devices” and/or “my destinations” and/or settings.

In some embodiments “my vehicles” includes a field for entry of one or more vehicle registration numbers.

In some embodiments “my devices” includes a field for one or more telephone numbers (mobile and/or VOIP and/or PSTN based numbers)

In some embodiments settings includes input options for user preferences. For example, radio buttons for “auto-select lowest price”, “auto-select closest spot to destination” and “show me options”. As an additional example radio buttons for “auto-select indoor spot if available”, “auto-select indoor spot if closest to destination” and “ask me every time if an indoor spot is required”. As an additional example, in some embodiments the settings portion of the user interface contains input options for auto-select first item in list after 0, 5, 10, 15, 30 or 60 seconds or intermediate or greater times. As an additional example, in some embodiments the settings portion of the user interface contains input options for maximum hourly rate. Alternatively or additionally, in some embodiments “my destinations” includes input fields for home and work locations and/or user selected locations.

Alternatively or additionally, in some embodiments system 100 populates the “my destinations settings” using recent parking events in event history DB 168 associated with the user via a user client device 122 and/or one or more vehicle registration numbers.

Exemplary Irregular Events

According to various exemplary embodiments of the invention system 100 is configured to handle irregular parking events of various types. Examples of irregular parking events include, but are not limited to, unreported entrance, and/or false reporting of entrance and/or false reporting of exit.

In some embodiments, unreported entrance is perceived by system 100 (FIG. 1) as a reservation cancellation after a predetermined amount of time. In these cases, the vehicle that parked without reporting their entrance is in violation. The violation is likely to be discovered by another user assigned to the same spot and/or by a warden.

In some embodiments false reporting of entrance is discovered by system 100 as duplicate parking events for the same vehicle at two different locations at the same time. In these cases the system responds by dispatching a warden and/or service vehicle to investigate.

In some embodiments false reporting of exit creates a violation situation for a vehicle that remains in a spot that was legitimately reserved for it.

Exemplary Machine Readable Data Considerations

Various systems and methods described hereinabove rely on location information in machine readable format (for example digitally encoded latitude and longitude coordinates to monitor and/or maintain status information pertaining to individual parking spots and/or to communicate a location of a reserved spot to a user client device and/or as in input for a mapping and/or navigation program.

According to various exemplary embodiments of the invention the machine readable format includes digital data and/or analog representations of that digital information (such as a QR code or bar code). In some embodiments the analog representations are printed.

In some embodiments the machine readable data includes an instruction which, when read by a user client device, launches an application on the user client device and provides access to relevant position coordinates to the newly launched application. Examples of suitable machine readable information formats include QR codes and/or barcodes and/or hypertext links. Exemplary instruction formats include QR codes, bar codes and hypertext links.

In some embodiments a vehicle navigation system receives machine readable location information in the form of digital location coordinates which are loaded directly into an already running application.

Exemplary Advantages

Systems and methods described hereinabove contributes to a reduction in maintenance of physical infrastructure (for example, parking meters and/or parking regulation signs and/or access gate), as a driver may be directed to a parking spot based on a GUI as exemplified in FIG. 7b.

Alternatively or additionally, systems and methods described hereinabove contribute to a reduction in supervision requirements (personnel and/or vehicles), for example, by use of violation system 130 in FIG. 1.

Alternatively or additionally, systems and methods described hereinabove contribute to a reduction in over-payments and under-payments relative to parking meters, for example, by using history DB 168 in FIG. 1.

Alternatively or additionally, systems and methods described hereinabove contribute to increased utilization of both public and private parking resources and/or to increased flexibility in managing parking resources as a whole and/or individual parking spots by use of a method for customizing parking spots to size of vehicle as exemplified in FIG. 4.

Alternatively or additionally, systems and methods described hereinabove enable advance reservation of a specific spot even in on-street parking situations.

Alternatively or additionally, systems and methods described hereinabove do not require sensors installed in spots, although they are amenable to use in the context of sensor based systems.

Various embodiments of system 100 described hereinabove provide control over previously un-monitored parking spots, such as no-cost parking. System 100 manages previously un-regulated no-cost parking spots and can enforce regulations (e.g. parking duration time limits). In some embodiments enforcement of regulations on no-cost spots contributes to greater availability of these spots. Mapping and reservation of no-cost spots is as described hereinabove. This is done as shown and described above by mapping the no-cost parking spots and adding them to spot database 164 like any other spot. In some embodiments this additional regulation contributes to a public perception of increased parking availability.

Exemplary Network Communications

According to various exemplary embodiments of the invention data is transmitted across a network. According to various exemplary embodiments of the invention the networks include the internet and/or local area networks (for example, at a command and control center) and/or cellular communications networks (voice and/or data) and/or the public switched telephone network (PSTN).

First Exemplary Use Scenario

In many cases the regional authority is aware of the date of a special event which will disrupt traffic, weeks or even months ahead of the event. More specific details of the event and of the specific areas to be affected may not be known until much closer to the event.

Referring again to FIG. 1, CCC 151 prevents all parking reservations of the date of the event in the affected region well in advance This “blackout” status is imposed by implementing a rule in rule and spot manager 150 with “all drivers” and the date of the event” as attributes, “no parking” as the scheme assigning it the maximum priority (for example, 100) and applying it to all the spots in the affected region, in DB 164. As the event grows closer and planning details grow clearer, the blackout rule for the whole region can be gradually replaced by a set of rules which are geographically more specific and less exclusive to users wishing to park on the day of the event.

Where relevant, notices are sent to users (for example, subscribers and/or residents) informing them that their parking rights will be suspended for the day of the event.

Second Exemplary Use Scenario

Delivery trucks typically require oversized spots for short periods of time, for example, to load or unload merchandise. The oversized spots are typically required along known routes, at known locations and/or at a known schedule. To date, trucks stopping to load or unload typically extend into the street causing slowdown of cars and traffic congestion.

Referring to FIGS. 1 and 3, in some embodiments a truck registration number is entered through user client device 122 and the truck registration number is transmitted from the parking reservation server 120 to vehicle registration DB 162 as exemplified in flowchart 1300. In some embodiments the location of the truck may is known (e.g., based on GPS tracking of the user client device used for entering the truck registration number). Thus, based on location of the truck (e.g., when the location of the truck is proximate to a known loading or unloading location), at predetermined dates and/or hours during the day a pre-set additional size requirement is automatically employed 1355 for the truck registration number, resulting in calculation of an appropriately sized parking spot 1330 and automatic reservation 1340 of the spot, typically for a limited predetermined time period.

This feature enabled by methods and systems according to embodiments of the invention allows for suitable parking spots for trucks thereby contributing to a reduction in eliminating traffic congestion.

Third Exemplary Use Scenario

Referring now to FIG. 7c, in some embodiments business places want to reserve large enough parking spots near the business place for delivery trucks. According to these embodiments the owner of the store or other business subscribes to several contiguous parking sub units at the front of the store, for example, sub units 1730, 1731 and 1732, for certain days and for certain time slots on those days.

Fourth Exemplary Use Scenario

Venues such as sport stadiums typically have large parking areas which are filled to capacity during a sports event at the stadium but which are relatively empty at other times.

In some embodiments in order to provide more efficient utilization of a venue parking area, CCC 151 (FIG. 1) applies a rule of low rates or even free parking to all parking spots (or parking subunits) in the stadium area when there is no event in the stadium. In another embodiment the venue parking area is, when there is no sports event, as a park & ride area (transportation hub) with shuttles running from the parking area to a regional or city center. According to these embodiments, a parking spot in the venue parking area is suggested to drivers on the UI of user client device 122 in response to a user entering a destination in the city center.

During an event or typically a predetermined time prior to the event a rule change is applied to all spots in the stadium parking area through rule DB 166. According to various exemplary embodiments of the invention the rule change includes an increase in price and/or a limit on allowed parking duration. Alternatively or additionally, system 100 offers a discount for advance reservations for event parking, which reservations are stored at spot DB 164.

Exemplary Enforcement Considerations

Although many users might normally be reticent to inform on a vehicle that is guilty of a parking violation, system 100 encourages, or even requires, them to do so if an unauthorized vehicle is parked in a spot reserved for them. Spot reservation gives a sense of entitlement which makes reporting a violation seem more acceptable. Alternatively or additionally, if an unauthorized vehicle is parked in a spot reserved for a user, the user needs to report the event to the system in order to receive an alternate spot.

In some embodiments a user client device 122 is operated by a warden, for example, an officer of the municipality. In some embodiments a UI of a user client device 122 used by a warden includes a map or other representation of a region showing available and non-available parking spots or subunits. In some embodiments a warden is referred to specific parking spots through violation system 130 and/or the warden identifies violations by comparing the map on user client device 122 to the actual situation on-site. Alternatively or additionally, in some embodiments the wardens photographs a license plate of an offending vehicle. In some embodiments the license plate number is scanned by OCR to facilitate issue of a report 131 by violation system 130. According to various exemplary embodiments of the invention the OCR is done at user client device 122 and/or at server 120.

Exemplary Backup Considerations

In some exemplary embodiments of the invention, for example when system 100 is applied to a region such as a municipality which is transitioning from a current or default status in which municipal parking rules are posted on signs or painted on pavements and/or curbs the computerized system of FIG. 1 overrides the previously installed visual instructions, so long as the system is functioning. In some embodiments as long as the various communications networks of system 100 are in working order, then the only way to legally park in the city is through system 100.

In case of a failure of system 100, or a component communications networks, or other operational component, predetermined default parking rules are available to all.

For example, in some embodiments signs and painted markings apply when the system is down (This is analogous to a stop sign at an intersection with a traffic light; the stop sign is in position for times when the traffic light does not function).

Alternatively or additionally, system 100 includes a backup database storing the city's “default” settings for each parking spot in a downfall situation. In some embodiments “default” settings are available for download to a user client device for future use. Alternatively or in addition printed maps of the city's “default” settings are posted on billboards, or in the printed or electronic media, and the like.

After the system is back “up” a grace period is permitted in which cars that parked according to the default settings are not ticketed.

Additional Exemplary Considerations

In some embodiments system 100 includes a queue management module managing (DB 172 in FIG. 1) a queue of parking requests. In some embodiments parking requests are prioritized based on different parameters as described herein. In one embodiment parking requests are prioritized based on a user's (e.g., driver's) reputation. In some embodiments a driver's reputation is saved as part of a user profile. For example, in some embodiments a driver (represented by their user client device, e.g., UCD 122a) that repeatedly violates is given negative points by the queue management module whereas drivers that abide by the rules are given positive points. Alternatively or additionally, in some embodiments a driver's reputation is based on the amount of positive and negative points accumulated in the queue management module. In one embodiment a user's reputation is used to change the priority of a parking request in a queue, e.g., to offer better conditions (e.g., less waiting time) to a driver having more positive points and/or offer worse conditions to a driver having more negative points.

In some embodiments a warden is given a suggested route to check for violations using a map provided to the warden from CCC 151 (FIG. 1). In some embodiments system 100 adjusts itself to “add” notifications when additional violations occur along the route and/or generate new routes which incorporate newly registered violations. In some embodiments, this feature contributes to an increase in the number of citations/unit time from a single warden.

In some embodiments method 2700 (FIG. 7a), includes providing suggested routes to a warden, e.g., the most efficient route for the warden to walk (or otherwise travel) to a parking spot of interest. Parking spots of interest include, for example, parking spots due to expire in 5; 10; 15 or 20 minutes or smaller or intermediate periods of time and/or parking spots where a violation has been reported and/or other parking spots where a warden's checkup is desired.

Alternatively or additionally, in some embodiments the suggested route is based on a known location of the warden (e.g., based on the GPS location of the warden's user client device 2800 (FIG. 7b)) and/or based on known locations of parking spots of interest.

In some exemplary embodiments of the invention, a warden is assisted by camera based or other sensors located and positioned along streets and other parking areas to monitor parking spots (e.g., by detecting and recording vehicle license plate numbers using OCR technology). In some embodiments a warden uses the information provided by the camera and/or sensors to report status changes of parking spots and/or violations. Alternatively or additionally, in some embodiments a route is suggested to the warden (as described above) based on the information provided by the sensors. In some embodiments the suggested route is based on a known location of the warden (e.g., based on the GPS location of the warden's user client device 2800 (FIG. 7b)) and/or based on known locations of parking spots of interest.

In some embodiments a status of specific parking spots is updated in DB 164 (e.g., from “occupied” to “available”) based on reports from user client devices (such as devices 122a or device 2800). In some embodiments the status of specific parking spots is updated in DB 164 based on input from a sensor located and positioned along streets and other parking areas to allow monitoring of parking spots. According to various exemplary embodiments of the invention the sensors include cameras and/or RFID tags located at each parking spot or parking subunit. For example, in some embodiments RFID tags are integrated into pavements or roads at each parking subunit. According to these embodiments, RF readers in vehicles allow system 100 (FIG. 1) to identify vehicles (specifically which vehicles) that have entered or exited specific parking spots. Alternately RFID tags are located in vehicles and RF readers are located at parking spots.

In some embodiments method 3700 includes receiving 3740 a confirmation of parking in a reserved spot and/or of exiting a reserved spot based on input from a sensor monitoring the spot, such as an RFID sensor capable of communication with the system.

In some embodiments parcels of land or parking subunits are marked by painted markings (such as lines demarcating each parking subunit) on pavements or roads. Alternatively or additionally, in some embodiments other markings are used (e.g., in geographical regions suffering from harsh weather such as snow and fog), such as sign posts or other appropriate techniques.

In some embodiments, in order to facilitate identification of a parking spot, numbers or other identifying characters are placed adjacent to the end of the lines demarcating each parking subunit. Sidedness may be indicated for example by the addition of “L” or “R” to the identifying characters, based on which side of the road the parking spot is located. In some embodiments each marking has an adjacent color painted (or otherwise applied) on the pavement/street. In some embodiments the colors appear in a fixed sequence (eg. RGB—Red, Green Blue). Alternatively or additionally, in some embodiments each identifying character (or group of characters) has a corresponding color thereby making it easier to identify a parking spot (e.g., trying to identify a spot composed of subunit 244 Green or 42 Blue). Alternatively or additionally, in some embodiments different sided sidewalks are painted in a different color or numbered (e.g., odd/even), facilitating identification of parking spots.

In some embodiments privately owned spots, or other off-street parking subunits are marked with similar markings as on-street parking subunits to facilitate identification of all parking spots within system (e.g. system 100).

According to some embodiments of the invention privately owned spots, or other off-street parking subunits or spots are included in system 100, thereby enabling enforcement (e.g., by wardens) and other advantages of the system in privately owned and other off-street parking spots for the benefit of the off-street parking spot owners.

Alternatively or additionally, in some embodiments system 100 is backed up by mirroring servers and/or DBs in different location. If one of the servers crashes, incoming communications from UCDs 122 are directed to the mirror.

In some embodiments, in case of failure or shutdown of the entire system including backups a procedure is initiated in which user client devices 122 are notified and are requested to manually switch or are automatically switched to off-line mode. According to these embodiments, off-line mode devices receive parking rules and/or a driver parks using default parking rules. In some cases additional features are provided. Additional features in this context include, but are not limited to billboards advising drivers of parking rules during system failure.

In some embodiments drivers continue to report arrival at a reserved parking spot and/or exit from the parking spot in offline mode. According to these embodiments offline mode reports are stored on the user client devices 122. Once system 100 is back up, reports stored in user client devices 122 are uploaded to system 100 and server 120 updates event history DB 168 with offline mode parking events. In some cases, by statistically analyzing the events (based on history analytics), the system determines how many events should have occurred and also how many were reported, thereby deriving the percent of “unreported” events. In some embodiments the unreported events are accommodated by increasing an occupancy buffer to handle larger margins of error (e.g., if it is determined that only 80% of the actual parking events were reported, 20% extra free spaces can be left open to allow reallocation for people requesting spots that were occupied).

In some embodiments in case of failure of data networks providing communication between UCDs 122 and server 120 (which may effect for example 3G based user client devices), users park using unaffected functions of their devices, such as by using SMS messaging and/or Interactive voice response (IVR) and/or unaffected devices such as kiosk 2900 (FIG. 9) or devices at call centers.

Alternatively or additionally, in some embodiments in case of failure of phone networks drivers park using devices such as kiosk 2900 (FIG. 9) or warden's devices.

Alternatively or additionally, in some embodiments basic vehicle details such as size and color may are pre-stored on user client device 122 to be used in case of failure of a DB at an external licensing authority from which vehicle DB 162 receives information regarding vehicle attributes. In some embodiments vehicles parking for the first time during failure of an external licensing authority DB are required to enter one or more details (e.g., by choosing a vehicle size from a list of several, e.g., 3 size categories and color from a list of colors) in order to reserve parking via system 100.

Alternatively or additionally, in some embodiments in case of failure of a navigation system associated with a user client device 122, a driver uses maps available from kiosk 2900 (FIG. 9) or another navigating systems or is directed by an operator at a call center.

Alternatively or additionally, in some embodiments in case of failure of payment methods operated by user client device 122, payment is achieved by other methods such as by paying at a kiosk 2900 (FIG. 9) or by mail.

It is expected that during the life of this patent many new types of user client devices and/or communications networks will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit are divided into subunits. Conversely, components and/or actions ascribed to exemplary embodiments of the invention and depicted as separate items/individual actions are combined into a single item/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

In some embodiments, two or more of methods depicted in FIGS. 6, 7a, 8a, 10, 11, 12, 13, 14, 15 and 17 and/or features from the textual descriptions of those methods are applied in processing a single parking reservation request. Alternatively or additionally, in some embodiments two or more of systems depicted in FIGS. 1, 3 and 5 and/or features from the textual descriptions of those systems. Alternatively or additionally, the user client device of FIG. 18 is incorporated into any or all of the above methods and/or systems in various embodiments of the invention.

Each recitation of an embodiment of the invention that includes a specific feature, part, component, module or process is an explicit statement that additional embodiments of the invention not including the recited feature, part, component, module or process exist. Specifically, the invention has been described in the context of parking but might also be used as a traffic control system.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A system comprising:
(a) a database of individual on-street parking spots, and individual off-street parking spots, each of said individual parking spots associated with a unique identifier (UID) and location coordinates; and
(b) an off street spot management module in communication with one or more external client devices, adapted to receive parking rules from an external client device operated by an owner of each of said individual off-street parking spots.

2. A system according to claim 1, comprising: a location definition module adapted to receive location coordinates defining a specific individual off-street parking spot from one of said one or more external client devices, assign a UID to said location coordinates to create an individual spot definition and add said spot definition to a spot database.

3. A system according to claim 1, comprising: a cue management module adapted to receive cue information to be used in guiding a vehicle to a specific individual off-street parking spot and associate said cue information with said specific spot in a spot database.

4. A system according to claim 1, wherein said off street spot management module resides on a reservation server.

5. A system according to claim 1, wherein said off street spot management module resides on an external client device adapted to communicate with a reservation server.

6. A system according to claim 1, wherein at least some of said individual off-street parking spots are privately owned.

7. A system comprising:
(a) a database of individual parking spots, each of said individual parking spots associated with a unique identifier (UID) and location coordinates and a current availability status;
(b) a reservation management server adapted to receive user parking requests from user client devices, each request including a destination;
(c) a suggestion engine adapted to transmit prompts including hourly parking rate and distance from destination for parking spots to said user client devices at least until an order is received at said server from said user client device or said request is cancelled by said user client device;
(d) a reservation engine that transforms said order into a reservation by changing an availability status of an ordered spot to not available.

8. A system according to claim 7, wherein said suggestion engine continues to transmit additional prompts after said order is received; each additional prompt having a shorter distance to destination and/or a lower hourly parking rate than said order; and wherein said reservation engine transforms a new order into a reservation and cancels a previous order received from a same user client device upon selection of one of said additional prompts from said user client device.

9. A system according to claim 7, comprising a cancellation management module adapted to receive cancellation requests from a user client device, and cancel a previous request or order made by said user client device.

10. A system according to claim 8, wherein said prompts include additional information.

11. A system according to claim 8, wherein said additional prompts indicate individual spots which were not available when said parking request was received.

12. A system comprising:
(a) a database of individual parking spots, each of said individual parking spots associated with a unique identifier (UID) and location coordinates and a current availability status;
(b) a reservation management server adapted to receive user parking requests from user client devices coupled to a position tracker via a network, each request including a destination;
(c) a tracking engine monitoring progress of each position tracker towards the destination defined in the request from the client device coupled thereto and issuing a push signal when a threshold proximity to destination is crossed; and
(d) a suggestion engine responding to said push signal by transmitting a location of at least one individual parking spot to said user client device as a spot suggestion.

13. A system according to claim 12, wherein said suggestion engine transmits only one spot suggestion and reservation management server transforms the suggestion to a reservation.

14. A system according to claim 13, comprising a user profile, wherein said suggestion engine chooses said one spot based on said user profile.

15. A system according to claim 12, wherein said suggestion engine transmits several spot suggestions to said user client device and a choice is received at said reservation management server from said user client device.

16. A system according to claim 12, wherein said threshold is defined in terms of distance from destination.

17. A system according to claim 12, wherein said threshold is defined in terms of estimated arrival time.

18. A system according to claim 12, wherein said threshold includes maximum speed as second variable.

19. A method comprising:
(a) receiving at a reservation management server from a user client device a bulk parking order for a future time, said bulk parking order defining a number of spots required, a desired parking duration, a start time, destination and a maximum distance therefrom;
(b) responding to said bulk parking order by transmitting a map of available parking spots at said future time for said desired parking duration from said start time and within said maximum distance from said destination to said user client device;
(c) receiving at said reservation management server an order indicating specific spots on said map and transforming said bulk parking order to a bulk parking reservation for said indicated spots.

20. A method according to claim 19, comprising returning to said user client device a redemption token.

21. A method according to claim 19, wherein a maximum amount of time in the future said bulk parking order can be made varies as a function of the number of spots defined by the order.

22. A method according to claim 19, comprising providing an invitation redemption portal adapted to assign specific vehicle registration numbers to said specific spots defined in said bulk parking reservation.

23. A method comprising:
(a) receiving, at a reservation management server, a query including location coordinates from a tracking component in a user client device equipped with a display;
(b) responding to said query by transmitting a portion of a map including said location coordinates, said map depicting parking spots and indicating for each spot whether its current status in the system is occupied, empty or reserved; said map displayable on said display.

24. A method according to claim 23, comprising displaying a vehicle registration number of car that ordered a spot for each spot indicated as reserved on said map.

25. A method according to claim 23, comprising populating said spots on said map indicated as occupied with virtual reality depictions of relevant cars.

26. A method according to claim 23, comprising populating said spots on said map indicated as reserved with virtual reality depictions of relevant cars.

27. A method according to claim 23, comprising displaying text describing relevant cars in association with said spots on said map indicated as occupied.

28. A method according to claim 23, comprising presenting said map on said user client device in perspective view.

29. A method according to claim 23, comprising updating said map as said location coordinates of said user client device change.

30. A method according to claim 23, comprising updating said map as said current status of one or more spots changes.

31. A method according to claim 23, comprising receiving at said reservation management server a status change input from said user client device and updating a status of said spot in accord with said input.

32. A method according to claim 31, wherein said input switches a status of an individual spot to occupied.

33. A method according to claim 31, wherein said input switches a status of an individual spot from occupied to vacant.

34. A method comprising:
(a) transmitting location information for a specific parking spot from a parking reservation management server to a user client device;
(b) transmitting supplementary context information about said specific parking spot from said server to said user client device.

35. A method according to claim 34, wherein said supplementary context information includes location information.

36. A method according to claim 34, comprising monitoring proximity of said user client device to said specific spot and transmitting said supplementary context information when a proximity threshold is crossed.

37. A method according to claim 34, wherein said supplementary context information describes a car in at least one flanking spot.

38. A method according to claim 34, wherein said supplementary context information describes an off street landmark.

39. A method according to claim 34, wherein said supplementary context information is provided as text.

40. A method according to claim 34, wherein said supplementary context information is provided as audio.

41. A method according to claim 34, wherein said supplementary context information is provided as a virtual reality representation of car currently parked in at least one flanking spot.

42. A method according to claim 34, comprising providing navigation instructions to the location defined by said location information.

43. A parking kiosk comprising:
(a) a user interface component accepting a vehicle registration number as an input;
(b) a request generator that that transmits the vehicle registration number to a parking reservation management server which assigns a specific parking spot to said vehicle registration number and generates a digital file encoding a map including navigation cues from the kiosk to said assigned spot and transmits said digital file back to the kiosk; and
(c) a map delivery apparatus.

44. A kiosk according to claim 43, wherein said map delivery apparatus comprises a printer that prints out the map encoded by the digital file.

45. A kiosk according to claim 43, wherein said map delivery apparatus comprises a data port for transmission of the map to an external device.

46. A kiosk according to claim 43, comprising a camera positioned to capture image of a user of said user interface component.

47. A kiosk according to claim 43, wherein said user interface component of kiosk accepts confirmation of parking and/or exit.

48. A kiosk according to claim 43, comprising a payment mechanism.

49. A kiosk according to claim 43, connected to a server via a wired network connection.

50. A method comprising:
(a) receiving a request to park a vehicle at a reservation management server from a user client device;
(b) determining attributes of the vehicle; and
(c) searching a spot DB to identify spots with features corresponding to said vehicle attributes.

51. A method according to claim 50, wherein said request includes a vehicle identification number and said determining includes retrieval of data from a vehicle DB.

52. A method according to claim 50, wherein said request includes a user identification and said determining includes retrieval of a user profile including attributes of the vehicle.

53. A method according to claim 50, wherein said vehicle attributes include physical characteristics.

54. A method according to claim 50, wherein said vehicle attributes include status characteristics.

55. A method according to claim 50, wherein said request includes a destination.

56. A method according to claim 50, wherein said request includes a user preference.

57. A method comprising:
(a) receiving at a reservation management server a request to park including a destination from a user client device;
(b) compiling a list of available spots ahead of said user client device based on a current position and available travel direction of said user client device;
(c) transmitting at least position coordinates of least one spot on said list to said user client device.

58. A method comprising:
(a) receiving at a reservation management server a request to park from a user client device, said request including a destination;
(b) determining a category for the destination;
(c) transmitting to said user client device a set of suggested parking spots including at least one parking spot at an alternate destination in said destination category.

59. A method according to claim 58, wherein said determining includes a keyword analysis of said destination.

60. A method according to claim 58, wherein said destination includes a street address and said determining includes a query to a directory to determine what is at said address.

61. A method according to claim 58, wherein each parking spot in said set of suggested parking spots is characterized in terms of estimated wait time for availability.

62. A method-comprising:
receiving a parking request including a destination at a reservation management server; and
transmitting a prompt to accept assignment to a spot in proximity to public transportation hub to a user client device from which said request originated.

63. A method according to claim 62 comprising, analyzing said request to determine whether a stop for any public transportation route proving service from said hub is in proximity to said destination.

64. A method according to claim 63 comprising, including in said prompt information on how much closer to said destination said stop is than the available parking spot closest to said destination.

65. A method according to claim 63 comprising, including in said prompt information on how much money is potentially saved by using public transportation from said hub.

66. A method according to claim 63 comprising, including in said prompt information on how much time is potentially saved by using public transportation from said hub.

67. A method comprising:
(a) receiving a parking request including a vehicle registration number at a parking reservation server;
(b) accessing parking history for said vehicle registration number;
(c) identifying at least one parking preference in said history;
(d) transmitting one or more suggested parking spots to a user client device, accompanied by data pertaining to each identified preference for each spot.

68. A method according to claim 67, wherein said request includes a destination.

69. A method according to claim 68, wherein said transmitting is of a single parking spot reserved for said vehicle registration number.

70. A method according to claim 68, wherein said parking history includes duration of previous parking events for said destination.

71. A method according to claim 67, wherein said history includes destinations defined for previous parking events.

72. A method according to claim 67, comprising constructing a user profile based on said at least one preference.

73. A method comprising:
(a) transmitting a reservation for an initial parking spot to a user client device from a reservation management server in response to a parking request;
(b) receiving a problem notification related to said initial parking spot from said user client device at said server; and
(c) responding to said problem notification by transmitting a reservation for an alternate parking spot to said user client device.

74. A method according to claim 73, comprising dispatching a service resource to said initial parking spot to evaluate said problem notification.

75. A method according to claim 73, comprising suspending further reservations for said initial parking spot until a problem of said problem notification is resolved.

76. A method comprising
(a) receiving a parking request from a first user client device at a reservation management server;
(b) storing a reservation of a parking spot in response to said request;
(c) receiving a request for details of said reservation from a second user client device.

77. A method according to claim 76, comprising receiving a confirmation of parking in a spot reserved by said reservation.

78. A method according to claim 76, comprising receiving an exit notification for the parking spot.

79. A user client device comprising:
(a) a calendar reader that reviews entries in a digital calendar and prompts the user for confirmation that one or more future events presented in a list is a current destination and;
(b) a destination modification module that prompts the user for a parking reservation request and, upon confirmation issues said parking reservation request to a reservation management server via a network.

80. A device according to claim 79, comprising
(c) a mapping module displaying current position on a map based upon output from a tracking device in communication with an external navigation resource.

81. A device according to claim 80, wherein said external navigation resource comprises a GNSS system (Global Navigation Satellite System).

82. A device according to claim 80, wherein said external navigation resource comprises at least one network communication station.
